(19) United States
(12) Patent Application Publication
(10) Pub. No.: US 2025/0329114 A1
(43) Pub. Date: Oct. 23, 2025

(54) THREE-DIMENSIONAL MEASUREMENT DEVICE

(71) Applicant: Keyence Corporation, Osaka (JP)

(72) Inventors: Masayasu IKEBUCHI, Osaka (JP); Tatsuro WAKAI, Osaka (JP); Atsushi MATSUTANI, Osaka (JP)

(73) Assignee: Keyence Corporation, Osaka (JP)

(21) Appl. No.: 19/254,067

(22) Filed: Jun. 30, 2025

Related U.S. Application Data
(63) Continuation of application No. PCT/JP2024/000596, filed on Jan. 12, 2024.

(30) Foreign Application Priority Data
Feb. 7, 2023 (JP) 2023-016774
Dec. 8, 2023 (JP) 2023-207986

(51) Int. Cl. G06T 17/20; G01B 11/25; G06T 7/73; G06T 15/04

(52) U.S. Cl. CPC G06T 17/20; G01B 11/2518; G06T 7/73; G06T 15/04; G06T 2207/10028; G06T 2207/20092; G06T 2207/30204; G06T 2210/56

(57) ABSTRACT

Information regarding a measurement result of a three-dimensional scanner can be easily confirmed on a three-dimensional scanner. A three-dimensional measurement device includes a three-dimensional scanner 2, a position and posture specifying unit that specifies a position and a posture of the three-dimensional scanner 2, and a three-dimensional data generation mechanism that generates display data indicating a three-dimensional shape of a measurement target based on an image including pattern light and the position and posture of the three-dimensional scanner 2 and transmits the generated display data. The three-dimensional scanner 2 receives the display data from the three-dimensional data generation mechanism. A scanner display unit 113 displays a display screen generated based on the display data received by the three-dimensional scanner.

### CROSS-REFERENCE TO RELATED APPLICATIONS

The present application is a continuation of International Application No. PCT/JP2024/000596, filed Jan. 12, 2024, which in turn claims foreign priority based on Japanese Patent Application No. 2023-016774, filed Feb. 7, 2023 and No. 2023-207986, filed Dec. 8, 2023, the contents of which are incorporated herein by references.

### TECHNICAL FIELD

The disclosure relates to a three-dimensional measurement device including a three-dimensional scanner.

### BACKGROUND ART

For example, Patent Literature 1 discloses that three-dimensional coordinate measurement of a measurement target is performed using a contact-type probe having a contact part to be brought into contact with a desired part of the measurement target. In Patent Literature 1, images of a plurality of markers provided in the contact-type probe can be captured by an imaging unit installed at a position distant from the contact-type probe, and three-dimensional coordinates of a contact position of the contact-type probe can be calculated based on a marker image generated by the imaging unit.

The contact-type probe of Patent Literature 1 is provided with a display unit that displays a setting screen including a measurement item, and a measurement worker can perform an operation of selecting a setting item while viewing the setting screen displayed on the display unit.

### CITATION LIST

### Patent Literature

Patent Literature 1: JP 2020-20700 A

### SUMMARY OF INVENTION

### Technical Problem

Meanwhile, coordinates can be measured only at a part in contact with the probe since the probe is of the contact type in a device in Patent Literature 1. Therefore, if a non-contact type three-dimensional scanner is used, measurement of a wider range of the measurement target, that is, scanning of a wide range is possible. When the measurement worker scans the measurement target by the three-dimensional scanner, it is necessary to pay attention to matters such as whether a distance between the measurement target and the three-dimensional scanner is appropriate, whether a portion desired to be measured in the measurement target has been irradiated with pattern light, and how much a current scan completion range is.

In order to confirm the distance between the measurement target and the three-dimensional scanner, the portion irradiated with the pattern light, and the scan completion range, it is necessary to view a display screen on which these matters are displayed. However, since a general display screen is displayed on a monitor of a personal computer constituting a device body, when the three-dimensional scanner is operated at a place distant from the personal computer, the measurement worker has to move to the personal computer and confirm the above-described matters, which is not easy to use.

In this regard, although the contact-type probe of Patent Literature 1 is provided with the display unit, the display unit only displays the setting screen. In addition, since the contact-type probe is brought into contact with the measurement target to perform measurement, it is not necessary to see a distance to the measurement target, and the measurement worker already knows a contact portion, and thus not need to confirm the contact portion on the display screen. Therefore, in the case of the contact-type probe of Patent Literature 1, problems as in the time of scanning the measurement target by the three-dimensional scan described above are not likely to occur.

The disclosure has been made in view of such a point, and an object thereof is to enable information regarding a measurement result of a three-dimensional scanner to be easily confirmed on the three-dimensional scanner.

### Solution to Problem

In order to achieve the above object, according to one aspect of the disclosure, a three-dimensional measurement device that measures a three-dimensional shape of a measurement target can be assumed. The three-dimensional measurement device includes: a three-dimensional scanner including a scanner light source that emits pattern light, a scanner imaging part that captures the pattern light emitted by the scanner light source to generate an image including the pattern light, a scanner display unit, and a first communication unit that receives display data for generating a display screen to be displayed on the scanner display unit; a position and posture specifying unit that specifies a position and a posture of the three-dimensional scanner; and a three-dimensional data generation mechanism that generates display data indicating the three-dimensional shape of the measurement target based on the image including the pattern light generated by the scanner imaging part and the position and posture of the three-dimensional scanner specified by the position and posture specifying unit, and includes a second communication unit that transmits the generated display data. The first communication unit of the three-dimensional scanner receives the display data transmitted via the second communication unit. The scanner display unit can display the display screen generated based on the display data received via the first communication unit.

According to this configuration, the three-dimensional data generation mechanism generates the display data indicating the three-dimensional shape of the measurement target based on the image generated by the scanner imaging part of the three-dimensional scanner and the position and posture of the three-dimensional scanner specified by the position and posture specifying unit. The display data is received from the second communication unit of the three-dimensional data generation mechanism via the first communication unit of the three-dimensional scanner. Since the display screen generated based on the display data received via the first communication unit is displayed on the scanner display unit, a measurement worker can easily confirm, on the three-dimensional scanner, matters such as information regarding a measurement result of the three-dimensional scanner, that is, whether a distance (working distance) between the measurement target and the three-dimensional scanner is appropriate, whether a portion desired to be measured in the measurement target has been irradiated with the pattern light, and how much a current scan completion range is only by viewing the scanner display unit. The display screen may be a screen displaying a point cloud indicating the three-dimensional shape of the measurement target or a screen displaying mesh data indicating the three-dimensional shape of the measurement target.

Further, the three-dimensional scanner may further include a scanner image processing unit that processes the image including the pattern light generated by the scanner imaging part to generate first measurement information, and a plurality of self-luminous markers. In this case, the first communication unit can also transmit the first measurement information generated by the scanner image processing unit. Further, the position and posture specifying unit includes: a movable imaging part that moves a field of view to make the three-dimensional scanner be within the field of view, and captures the self-luminous markers to generate an image including the self-luminous markers in order to measure the position and posture of the three-dimensional scanner; a camera image processing unit that processes the image including the self-luminous markers generated by the movable imaging part to generate second measurement information; and a third communication unit that transmits the second measurement information generated by the camera image processing unit. The three-dimensional data generation mechanism can receive the first measurement information generated by the scanner image processing unit and transmitted via the first communication unit and the second measurement information generated by the camera image processing unit and transmitted via the third communication unit, and generate the display data indicating the three-dimensional shape of the measurement target based on the received first measurement information and second measurement information. Further, the three-dimensional data generation mechanism may transmit the display data, and the first communication unit of the three-dimensional scanner may receive the transmitted display data.

As a result, the position and posture specifying unit and the three-dimensional scanner can be operated separately, for example, the three-dimensional scanner can be easily handled, and measurement workability is improved.

Further, the three-dimensional data generation mechanism may further include a measurement setting unit that receives a setting of at least one of a type of the pattern light emitted by the scanner light source and an exposure time of the scanner imaging part, and a measurement control part that controls the scanner light source or the scanner imaging part based on the setting received by the measurement setting unit. According to this configuration, it is possible to set the type of the pattern light and the exposure time on the spot while the measurement worker is at the measurement site, so that convenience is improved.

Further, since the scanner display unit displays a setting screen that receives the setting of at least one of the type of the pattern light emitted by the scanner light source and the exposure time of the scanner imaging part, the measurement worker can easily perform the setting while viewing the setting screen.

Further, the setting information received via the setting screen can be written in the measurement setting unit of the three-dimensional data generation mechanism, and in this case, the measurement control part of the three-dimensional data generation mechanism can control the scanner light source or the scanner imaging part based on the setting information written in the measurement setting unit.

Further, the three-dimensional data generation mechanism may also generate new display data indicating the three-dimensional shape of the measurement target based on a new image including the pattern light generated by the scanner imaging part controlled based on the setting information written in the measurement setting unit and the position and posture of the three-dimensional scanner specified by the position and posture specifying unit, and transmit the generated new display data. In this case, the scanner display unit can display a display screen generated based on new display data received via the first communication unit.

Further, distance information indicating a distance between the measurement target and the three-dimensional scanner, difference information representing a difference between CAD data of the measurement target and the measured three-dimensional shape, and the like can also be displayed on the display screen. Furthermore, it is also possible to display a display screen in which a color image of the measurement target generated by a texture camera is superimposed and displayed on the point cloud indicating the three-dimensional shape of the measurement target.

A three-dimensional measurement device including a scanner light source that emits pattern light for measuring a three-dimensional shape of a measurement target, and a scanner imaging part that captures the pattern light emitted by the scanner light source to generate an image including the pattern light may be provided. In this case, the three-dimensional measurement device can include: an input unit that receives an input of a reference model of the measurement target; a display data generation unit that causes a display unit to display the reference model as a solid body; a geometric element extraction unit that extracts a geometric element by receiving a user input on the reference model of which display data is generated by the display data generation unit and displayed as the solid body on a scanner display unit; a coordinate system creation unit that creates a coordinate system of the reference model based on the geometric element extracted by the geometric element extraction unit; a position and posture specifying unit that specifies a position and a posture of the three-dimensional scanner; a three-dimensional data generation mechanism that sequentially generates point cloud data of the measurement target in a measurement coordinate system based on the image including the pattern light generated by the scanner imaging part and the position and posture of the three-dimensional scanner specified by the position and posture specifying unit; and a coordinate system matching unit that aligns the coordinate system of the reference model created by the coordinate system creation unit and the measurement coordinate system. The reference model of the measurement target may be, for example, CAD data, polygon data (STL data), mesh data acquired in the past, or the like.

Then, the display data generation unit generates display data for displaying the reference model on the display unit in a state where the coordinate system of the reference model and the measurement coordinate system are matched by the coordinate system matching unit, switches the reference model from a solid display to a ridge line display in which a ridge line is emphasized in response to start of the generation of the point cloud data by the three-dimensional data generation mechanism, and generates display data for cumulatively displaying the three-dimensional shape based on the point cloud data of the measurement target sequentially generated by the three-dimensional data generation mechanism on the reference model in which the ridge line is displayed. The display data generation unit can generate the display data of the reference model in which a translucent solid of the reference model is displayed as the reference model in which the ridge line is displayed.

The three-dimensional measurement device may further include a measurement processing unit that executes measurement processing of the three-dimensional shape of the measurement target based on a series of the point cloud data sequentially generated by the three-dimensional data generation mechanism. Examples of the measurement processing includes geometric measurement, comparative measurement, and cross-section measurement.

The three-dimensional measurement device may further include a contact-type probe that indicates a position of a measurement point, and a coordinate calculation unit that calculates coordinates of a plurality of the measurement points indicated by the contact-type probe. The coordinate system creation unit can create the measurement coordinate system based on the coordinates of the plurality of measurement points calculated by the coordinate calculation unit.

The three-dimensional scanner may further include a scanner display unit and a first communication unit that receives the display data generated by the display data generation unit. The scanner display unit can receive and display, via the first communication unit, the display data for cumulatively displaying the three-dimensional shape based on the point cloud data of the measurement target in the measurement coordinate system created by the coordinate system creation unit.

The three-dimensional measurement device may further include a second communication unit that transmits the display data to the first communication unit of the three-dimensional scanner. The scanner display unit can display the display data generated by the display data generation unit and transmitted to the three-dimensional scanner via the second communication unit and the first communication unit.

Further, the display data generation unit can generate the display data such that the pattern light included in the image generated by the scanner imaging part is displayed on the reference model in different colors on the display unit according to a distance between the scanner imaging part and the measurement target.

The three-dimensional measurement device may further include a region deletion unit that deletes the point cloud data of a region indicated by a user input by receiving the user input on the three-dimensional shape of the measurement target displayed on the display unit as the display data is generated by the display data generation unit.

The three-dimensional measurement device may further include a texture camera that captures an image of the measurement target to generate a texture image including a texture of the measurement target. The position and posture specifying unit can specify a position and a posture of the texture camera. The display data generation unit can display a three-dimensional texture image in which the texture image acquired by the texture image acquisition unit is applied on the three-dimensional shape data based on the position and posture of the texture camera when the texture image is acquired.

The display data generation unit may generate display data for superimposing and displaying the texture image at a predetermined time point acquired by the texture camera on cumulatively displayed pieces of the point cloud data sequentially generated over a predetermined period and generated by the three-dimensional data generation mechanism, and transmit the generated display data to the first communication unit. The predetermined period can be, for example, a period from start of measurement to completion of measurement. Then, the scanner display unit can display the display data received via the first communication unit.

### Advantageous Effects of Invention

As described above, since the display screen generated based on the display data indicating the three-dimensional shape of the measurement target can be displayed on the scanner display unit of the three-dimensional scanner, the measurement worker can easily confirm the information regarding the measurement result of the three-dimensional scanner on the three-dimensional scanner.

### BRIEF DESCRIPTION OF DRAWINGS

FIG. 1 is a view illustrating a configuration of a three-dimensional scanner according to an embodiment of the invention.

FIG. 2 is a block diagram of an imaging unit and a processing unit.

FIG. 3 is a perspective view of a three-dimensional scanner as viewed from below.

FIG. 4 is a right side view of the three-dimensional scanner.

FIG. 5 is a plan view of the three-dimensional scanner.

FIG. 6 is a bottom view of the three-dimensional scanner.

FIG. 7 is a front view of the three-dimensional scanner.

FIG. 8 is a cross-sectional view of the three-dimensional scanner taken along an up-down direction.

FIG. 9 is a block diagram illustrating a circuit configuration of the three-dimensional scanner.

FIG. 10 is a view illustrating an example of a setting screen.

FIG. 11 is a flowchart illustrating an example of a procedure for reflecting setting information.

FIG. 12 is a view illustrating a first example of a display screen displaying point clouds.

FIG. 13 is a view illustrating a second example of the display screen displaying point clouds.

FIG. 14 is a view illustrating a third example of the display screen displaying the point clouds.

FIG. 15 is a view illustrating a fourth example of the display screen displaying the point clouds.

FIG. 16 is a flowchart illustrating an example of a procedure of processing when a viewpoint is fixed.

FIG. 17 is a view illustrating an example of the display screen representing a difference between CAD data of a measurement target and a measurement result.

FIG. 18 is a view illustrating an example of the display screen in a case where texture is reflected.

FIG. 19 is a flowchart illustrating an example of a procedure of processing for reflecting the texture.

FIG. 20 is a flowchart illustrating an example of a procedure of three-dimensional shape measurement of the measurement target by the three-dimensional scanner.

FIG. 21 is a flowchart illustrating an example of a procedure of data matching processing.

FIG. 22 is a view illustrating a case where the three-dimensional scanner is attached to an arm and operated.

FIG. 23 is a flowchart illustrating an example of a procedure of three-dimensional measurement.

FIG. 24 is a view corresponding to FIG. 2 according to another example.

FIG. 25 is a view illustrating an example in which a three-dimensional model is displayed on a monitor as a solid body.

FIG. 26 is a perspective view of a probe.

FIG. 27 is a block diagram illustrating a circuit configuration of the probe.

FIG. 28 is a diagram illustrating an example of a user interface when the three-dimensional scanner is switched from an inactive state to an active state to execute a measurement operation.

FIG. 29 is a view illustrating an example of a display form in which a ridge line is emphasized.

### DESCRIPTION OF EMBODIMENTS

Hereinafter, an embodiment of the invention will be described in detail with reference to the drawings. Note that the following preferred embodiment is described merely as an example in essence, and there is no intention to limit the invention, its application, or its use.

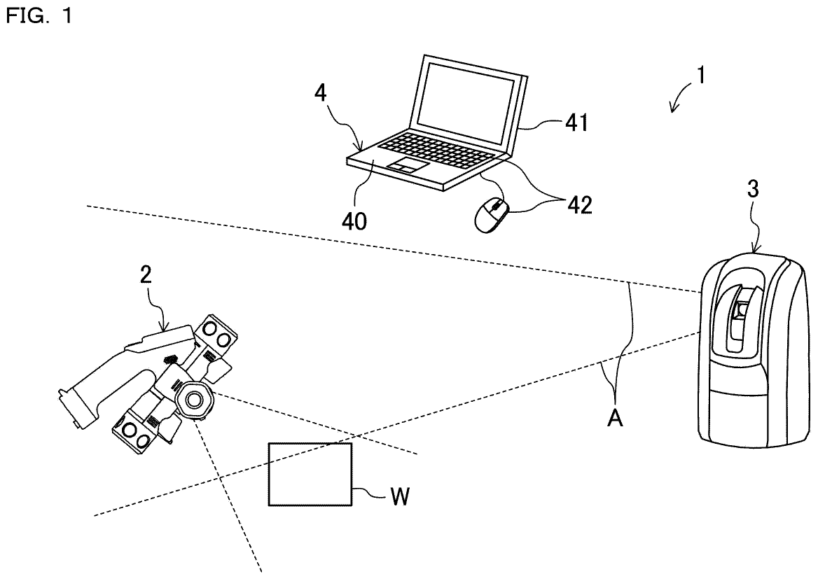

FIG. 1 is a view illustrating a configuration of a three-dimensional measurement device 1 according to the embodiment of the invention. The three-dimensional measurement device 1 is a shape measuring instrument that measures a three-dimensional shape and three-dimensional coordinates of a measurement target W without coming into contact with the measurement target W, and includes a three-dimensional scanner 2 having a plurality of self-luminous markers, an imaging unit 3 that captures images of the plurality of self-luminous markers provided in the three-dimensional scanner 2; a processing unit 4 that measures the three-dimensional shape and the three-dimensional coordinates of the measurement target based on a marker image generated by the imaging unit 3 and a bright line image generated by the three-dimensional scanner 2. The three-dimensional scanner 2 is provided separately from the imaging unit 3 and the processing unit 4, and a measurement worker can bring the three-dimensional scanner 2 to the vicinity of the measurement target W located at a place distant from the imaging unit 3 and the processing unit 4 and cause the three-dimensional scanner 2 to generate a bright line image.

### Configuration of Imaging Unit 3

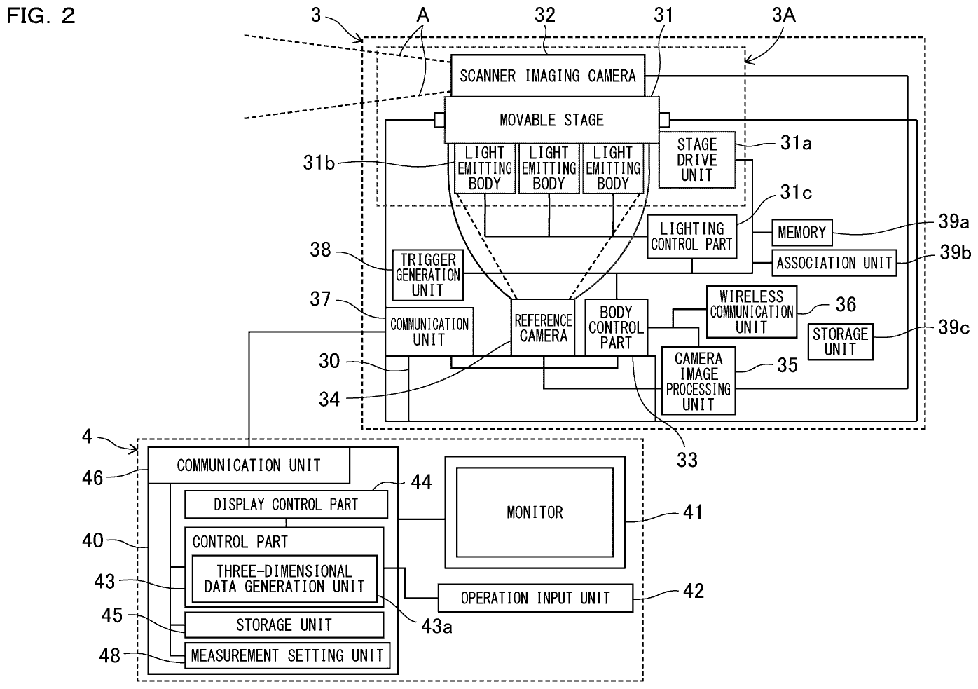

The imaging unit 3 is an example of a position and posture specifying unit that specifies a position and a posture of the three-dimensional scanner 2, and is, for example, a unit that captures images of a plurality of self-luminous markers (described later) provided in the three-dimensional scanner 2 to generate a marker image including the plurality of self-luminous markers. The marker image including the self-luminous markers can also be referred to as a second image. As illustrated in FIG. 2, the imaging unit 3 includes a base 30 and a movable imaging part 3A that moves a field of view such that the three-dimensional scanner 2 is within the field of view, and captures images of the self-luminous markers to measure the position and the posture of the three-dimensional scanner 2 to generate the marker image including the self-luminous markers. The movable imaging part 3A includes a movable stage 31 supported by the base 30 and a scanner imaging camera 32 fixed to an upper portion of the movable stage 31. The movable stage 31 includes a stage drive unit 31a. The stage drive unit 31a incorporates an actuator such as a motor, and is configured to rotate the movable stage 31 about a left-right axis as well as a vertical axis. Further, the scanner imaging camera 32 rotates about the vertical axis by rotating the movable stage 31 about the vertical axis, and the scanner imaging camera 32 rotates about the left-right axis by rotating the movable stage 31 about the left-right axis. As a result, the self-luminous marker can be tracked by moving a field of view (schematically indicated by broken lines A in FIGS. 1 and 2) of the scanner imaging camera 32 such that the three-dimensional scanner 2, that is, the plurality of self-luminous markers provided in the three-dimensional scanner 2, enter the field of view of the scanner imaging camera 32. The stage drive unit 31a is controlled by a body control part 33 provided in the imaging unit 3.

In a lower portion of the movable stage 31, a plurality of light emitting bodies 31b are provided at predetermined intervals on a two-dimensional plane, and the light emitting bodies 31b are switched between a turned-on state and a turned-off state by a lighting control part 31c. The plurality of light emitting bodies 31b move as the scanner imaging camera 32 and the movable stage 31 move. The lighting control part 31c is controlled by the body control part 33. On the other hand, the base 30 is provided with a reference camera 34 that captures an image of the movable imaging part 3A. The reference camera 34 captures an image of the light emitting body 31b turned on by the lighting control part 31c. The reference camera 34 captures images of a plurality of the light emitting bodies 31b provided in the movable imaging part 3A and generates an image including the light emitting bodies 31b. Further, the reference camera 34 can also be referred to as a fixed imaging part, and the image including the light emitting bodies 31b can also be referred to as a third image. The reference camera 34 is provided to capture the image of the light emitting body 31b turned on by the lighting control part 31c. Note that the plurality of light emitting bodies 31b can also be referred to as self-luminous markers provided in the movable imaging part 3A. The marker provided in the movable imaging part 3A may be configured by a member serving as a mark other than the light emitting body 31b.

The imaging unit 3 is provided with a camera image processing unit 35. The camera image processing unit 35 includes an image processing circuit, and controls the scanner imaging camera 32 to execute imaging at a predetermined timing. Examples of the image processing circuit include a graphics processing unit (GPU), a field programmable gate array (FPGA), a digital signal processor (DSP), and the like.

The camera image processing unit 35 receives an input of the marker image captured by the scanner imaging camera 32 and an input of images of the light emitting bodies 31b captured by the reference camera 34.

The camera image processing unit 35 processes the marker image captured by the scanner imaging camera 32 to generate center position information (corresponding to second measurement information of the invention) of the self-luminous marker. Specifically, the camera image processing unit 35 performs processing of extracting the center of the self-luminous marker with respect to the marker image. Then, the center position information of the self-luminous marker is generated based on an extracted result. Furthermore, the camera image processing unit 35 generates position and posture information of the self-luminous marker with respect to a movable imaging part 3A based on the center position information of the self-luminous marker obtained as a result of the processing of extracting the center of the self-luminous marker.

Pieces of center position information of self-luminous markers 71 to 77, 81 to 87, 91 to 97, and 101 to 107 are generated by the following method. First, the camera image processing unit 35 acquires arrangement information of each of the self-luminous markers 71 to 77, 81 to 87, 91 to 97, and 101 to 107 stored in the three-dimensional scanner 2. Then, the camera image processing unit 35 calculates any position at which an image of each of the markers is captured by the imaging unit 3 when a relative position or posture of the three-dimensional scanner 2 with respect to the imaging unit 3 is changed based on the arrangement information of the self-luminous markers 71 to 77, 81 to 87, 91 to 97, and 101 to 107 acquired from the three-dimensional scanner 2 and relative three-dimensional position information between the markers included in the marker image generated by the camera image processing unit 35, and matches the calculated position of each of the markers with a marker position of an image 102. Then, a relative position and posture of the three-dimensional scanner 2 with respect to the imaging unit 3 in which an error between the calculated position of each of the markers and the marker position of the image 102 is minimized are calculated and generated as the center position information of each of the self-luminous markers 71 to 77, 81 to 87, 91 to 97, and 101 to 107. That is, the camera image processing unit 35 virtually changes the arrangement information of each of the self-luminous markers 71 to 77, 81 to 87, 91 to 97, and 101 to 107 acquired from the three-dimensional scanner 2 by virtually changing the position and posture of the three-dimensional scanner 2, calculates a position and a posture matching the marker image generated by the camera image processing unit 35, and generates the center position information of each of the self-luminous markers 71 to 77, 81 to 87, 91 to 97, and 101 to 107. This position and posture information calculation processing may be called bundle adjustment. Here, for the matching, some of the self-luminous markers 71 to 77, 81 to 87, 91 to 97, and 101 to 107 included in the marker image may be selectively used representative markers. The circular self-luminous markers 71 to 77, 81 to 87, 91 to 97, and 101 to 107 have an elliptical shape depending on the position and posture of the three-dimensional scanner 2. In this regard, as an example, an oblateness that is a ratio of lengths of a long side and a short side of each of the self-luminous markers 71 to 77, 81 to 87, 91 to 97, and 101 to 107 included in the marker image may be used to set the self-luminous markers 71 to 77, 81 to 87, 91 to 97, and 101 to 107 having the oblateness equal to or more than the predetermined value as representative markers while excluding a case where the oblateness is equal to or less than a predetermined value from calculation targets. Further, one close to a perfect circle in a marker block may be selected as a representative marker. As the self-luminous marker set as the calculation target is limited to the representative marker in this manner, it is possible to improve calculation speed and to suppress a decrease in measurement accuracy.

The center position information of each of the self-luminous markers 71 to 77, 81 to 87, 91 to 97, and 101 to 107 calculated here uses the scanner imaging camera 32 as a reference. In this regard, the camera image processing unit 35 calculates position and posture information of the three-dimensional scanner 2 using the reference camera 34 as a reference based on position and posture information of the scanner imaging camera 32 using the reference camera 34 as a reference and the position and posture information of the three-dimensional scanner 2 using the scanner imaging camera 32 as a reference, thereby generating the center position information of the self-luminous marker using the reference camera 34 as a reference.

The imaging unit 3 includes a wireless communication unit 36 that is controlled by the body control part 33. The wireless communication unit 36 is a communication module or the like configured to be capable of communicating with equipment other than the imaging unit 3. In this example, the imaging unit 3 communicates with the three-dimensional scanner 2 via the wireless communication unit 36, thereby enabling, for example, transmission and reception of various types of data such as image data captured by the scanner imaging camera 32, various signals, and the like.

The imaging unit 3 also includes a communication unit (corresponding to a third communication unit of the invention) 37 controlled by the body control part 33. The communication unit 37 is a communication module or the like configured to be capable of communicating with the processing unit 4. The imaging unit 3 communicates with the processing unit 4 via the communication unit 37, thereby enabling, for example, transmission and reception of various types of data such as image data and various signals. The communication by the communication unit 37 may be wired communication or wireless communication. The communication unit 37 transmits the center position information of the self-luminous marker generated by the camera image processing unit 35.

The imaging unit 3 includes the trigger generation unit 38 that generates identification information for identifying a synchronous execution timing based on a measurement instruction. For example, when the measurement worker performs a predetermined measurement start operation, the body control part 33 of the imaging unit 3 receives the measurement start operation. When receiving the measurement start operation, the body control part 33 causes the trigger generation unit 38 to generate a trigger as the above-described identification information. The trigger is transmitted to the three-dimensional scanner 2 via, for example, the wireless communication unit 36. Note that the trigger generation unit 38 can also be referred to as a synchronization mechanism.

In response to the generation of the trigger, the body control part 33 synchronously executes light emission of the self-luminous markers of the three-dimensional scanner 2, imaging of the self-luminous markers of the three-dimensional scanner 2 by the movable imaging part 3A, lighting of the light emitting bodies 31b of the movable stage 31, and imaging of the light emitting bodies 31b by the reference camera 34. Note that the light emitting bodies 31b of the movable stage 31 may be constantly turned on. Therefore, the body control part 33 executes at least the light emission of the self-luminous markers of the three-dimensional scanner 2, the imaging by the movable imaging part 3A, and the imaging by the reference camera 34 in synchronization. A timing of the light emission of the self-luminous markers of the three-dimensional scanner 2 may be slightly earlier than a timing of the imaging by the movable imaging part 3A. In this case as well, it is assumed that the light emission of the self-luminous markers of the three-dimensional scanner 2 is synchronized with the imaging by the movable imaging part 3A.

The communication unit 37 transmits center position information of a self-luminous marker generated by the camera image processing unit 35 and identification information corresponding to the center position information of the self-luminous marker generated by the trigger generation unit 38 to be tied to each other. The term “tying” means linking or associating two or more pieces of information. In this case, the center position information of the self-luminous marker is linked to the identification information for distinguishing the center position information of the self-luminous marker from center position information of another self-luminous marker. Thus, center position information of a desired self-luminous marker can be specified based on the identification information. The communication unit 37 corresponds to a second transmission unit of the invention. Note that the center position information of the self-luminous marker and the identification information may be transmitted by wireless communication.

### Configuration of Processing Unit 4

The processing unit 4 is a part that receives positions and postures of a plurality of markers obtained by processing a marker image generated by the imaging unit 3 from the imaging unit 3, receives edge data of a bright line image obtained by processing the bright line image generated by the three-dimensional scanner 2, and measures a three-dimensional shape of the measurement target W based on the received positions and postures of the markers and the edge data.

As a technique for measuring the three-dimensional shape, a conventionally known technique can be used. Hereinafter, an example will be described. Since the plurality of light emitting bodies 31b of the imaging unit 3 are provided on the movable stage 31 to which the scanner imaging camera 32 is fixed, a positional relationship of the plurality of light emitting bodies 31b with respect to the scanner imaging camera 32 is known. When the scanner imaging camera 32 is moved by the stage drive unit 31a, the scanner imaging camera 32 moves within a range in which images of the light emitting bodies 31b can be captured by the reference camera 34. A position and a posture of the three-dimensional scanner 2 with respect to the scanner imaging camera 32 are determined based on the marker image of the three-dimensional scanner 2 captured by the scanner imaging camera 32.

Further, the reference camera 34 similarly determines a position and a posture of the scanner imaging camera 32 with respect to the reference camera 34 based on the images obtained by capturing the plurality of light emitting bodies 31b. Specifically, the camera image processing unit 35 acquires pieces of the arrangement information of the light emitting bodies 31b stored in the storage unit 39c of the imaging unit 3, processes the images of the light emitting bodies 31b generated by the reference camera 34 based on pieces of the arrangement information of the light emitting bodies 31b, and generates the position and posture information of the scanner imaging camera 32 with respect to the reference camera 34. The position and posture information of the scanner imaging camera 32 with respect to the reference camera 34 can be referred to as third measurement information.

A position and a posture of the three-dimensional scanner 2 with respect to the reference camera 34 are determined from the position and posture of the three-dimensional scanner 2 with respect to the scanner imaging camera 32 and the position and posture of the scanner imaging camera 32 with respect to the reference camera 34, and coordinates of a measurement point are obtained, so that three-dimensional coordinate measurement, that is, three-dimensional shape measurement becomes possible.

FIG. 1 illustrates an example in which the processing unit 4 is configured by a general-purpose notebook personal computer. However, the processing unit 4 may be configured by a desktop personal computer, a controller dedicated to the three-dimensional measurement device 1, or the like. In any case, the processing unit 4 can be used by installing a program or an application for implementing functions of the three-dimensional measurement device 1. The processing unit 4 may be provided separately from the imaging unit 3 or may be integrated with the imaging unit 3. Further, a part of the processing unit 4 may be incorporated in the imaging unit 3, or a part of the imaging unit 3 may be incorporated in the processing unit 4.

As illustrated in FIG. 2, the processing unit 4 includes a control unit 40, a monitor 41, and an operation input unit 42. The monitor 41 is configured by a liquid crystal display, an organic EL display, or the like configured to be capable of displaying various images, a user interface, and the like.

The operation input unit 42 is a part by which a user performs various input operations. The operation input unit 42 includes, for example, a keyboard, a mouse, and the like.

The control unit 40 includes a control part 43, a display control part 44, a storage unit 45, and a communication unit 46. The display control part 44 is a part that controls the monitor 41 based on a signal output from the control part 43, and causes the monitor 41 to display various images, a user interface, and the like. The user's operation performed on the user interface is acquired by the control part 43 based on a signal output from the operation input unit 42.

The storage unit 45 may be a ROM, a solid state drive, a hard disk drive, or the like. The storage unit 45 stores arrangement information of each of the self-luminous markers in the marker blocks provided in the three-dimensional scanner 2. The arrangement information of the marker block and each of the self-luminous markers includes a distance between the marker blocks, information indicating a relative positional relationship of the self-luminous markers provided in each of the marker blocks, and the like.

Further, the communication unit 46 of the processing unit 4 is controlled by the control part 43. The communication unit 46 is a communication module or the like configured to be capable of communicating with the communication unit 37 of the imaging unit 3.

### Configuration of Three-Dimensional Scanner 2

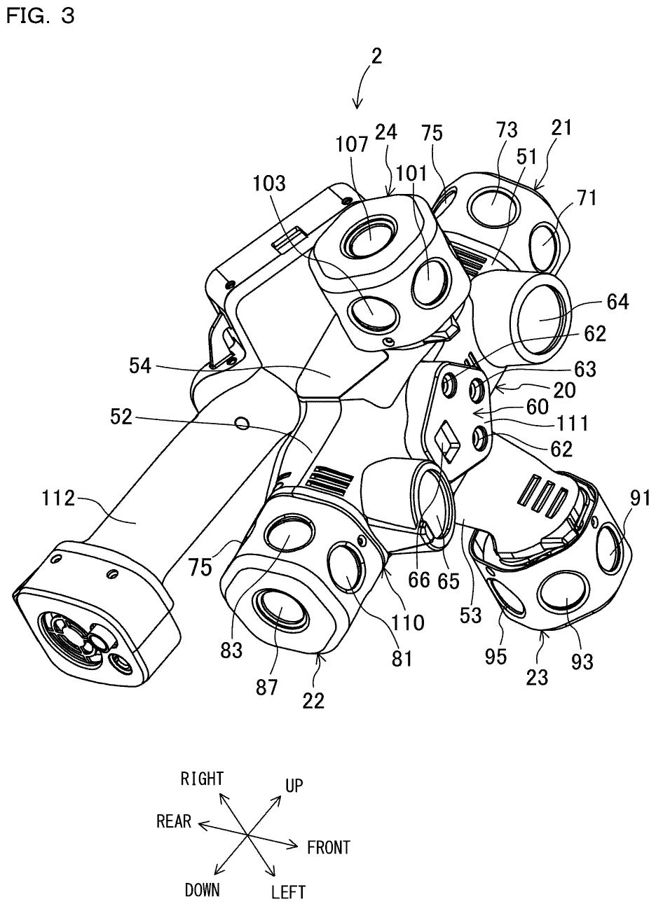

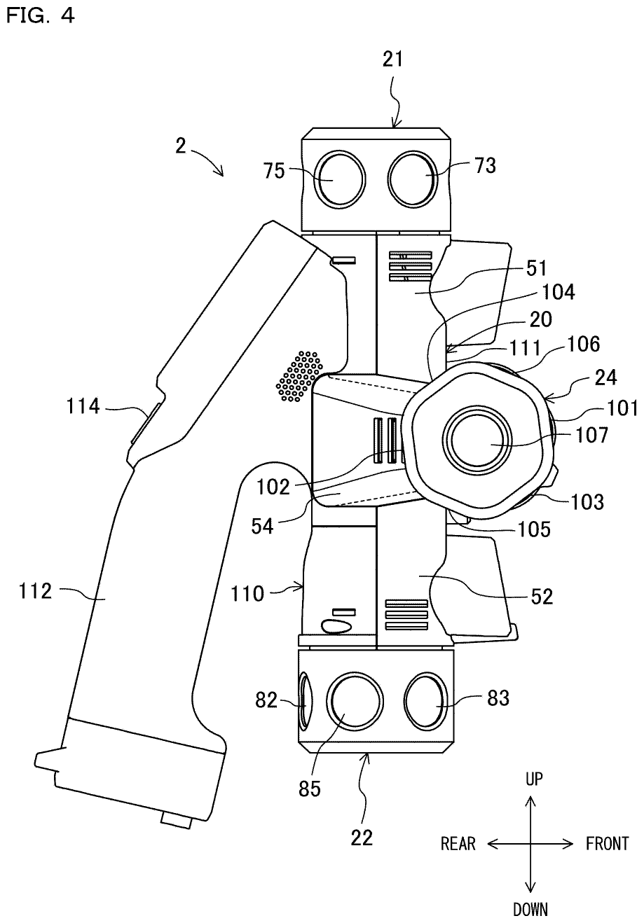

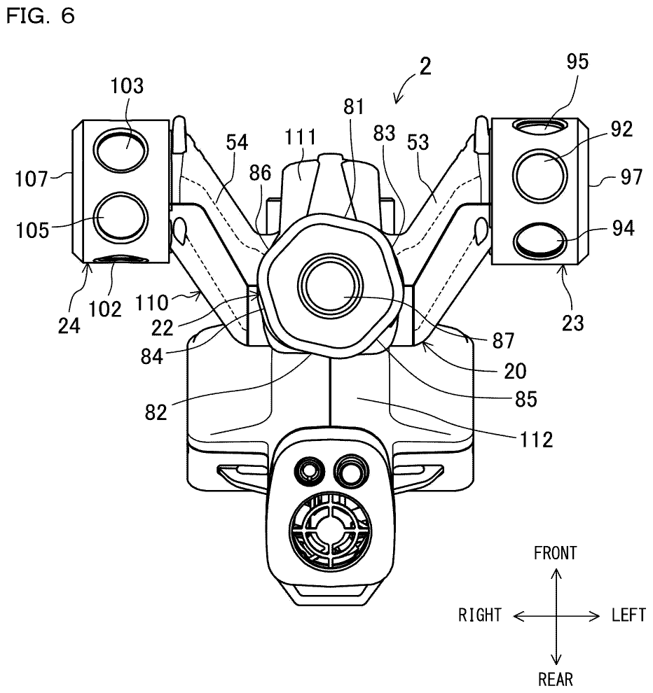

The three-dimensional scanner 2 is configured such that the measurement worker can measure the shape of the measurement target W while holding and freely moving the three-dimensional scanner 2 with one hand or both hands, and is a handheld and portable scanner. Power may be supplied from the outside, or supplied from a built-in battery. In the present embodiment, the front, rear, left, right, up, down of the three-dimensional scanner 2 are defined as illustrated in FIGS. 3 to 7. That is, when the measurement worker holds the three-dimensional scanner 2 by hand, a side located on the right is referred to as the right, and a side located on the left is referred to as the left. The front of the three-dimensional scanner 2 is a side opposing the measurement target W, and the rear side of the three-dimensional scanner 2 is a side opposite to the side opposing the measurement target W. The up of the three-dimensional scanner 2 is a side on the upper side in a state where a grip part 112, which will be described later, is gripped in a natural posture as determined, and the down of the three-dimensional scanner 2 is a side on the lower side in a state where the grip part 112 is gripped in the natural posture as determined. However, since the three-dimensional shape of the measurement target W can be measured while the three-dimensional scanner 2 is held and moved by hand as described above, the three-dimensional scanner 2 may have an orientation of being inverted upside down or a posture in which the upper side is located on the right or left, or the rear side thereof may be located at the up or down.

The three-dimensional scanner 2 includes the scanner body 20, a first marker block 21, a second marker block 22, a third marker block 23, and a fourth marker block 24. Although details will be described later, the first to fourth marker blocks 21 to 24 each have self-luminous markers facing a plurality of directions, respectively.

The scanner body 20 includes a first arm part 51 extending upward from a central portion, a second arm part 52 extending downward from the central portion, a third arm part 53 extending leftward from the central portion, and a fourth arm part 54 extending rightward from the central portion.

The first marker block 21 is attached to a distal end of the first arm part 51, the second marker block 22 is attached to a distal end of the second arm part 52, the third marker block 23 is attached to a distal end of the third arm part 53, and the fourth marker block 24 is attached to a distal end of the fourth arm part 54.

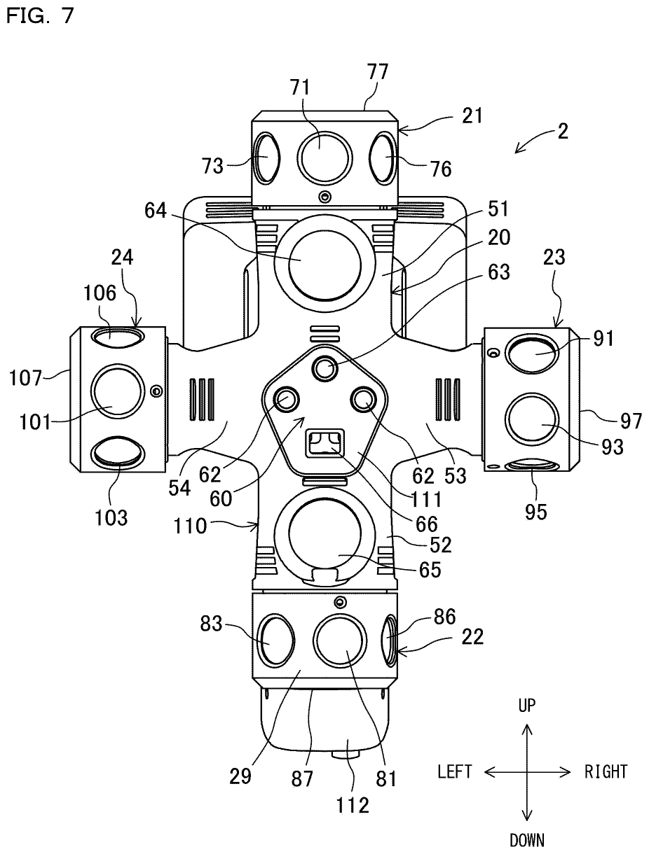

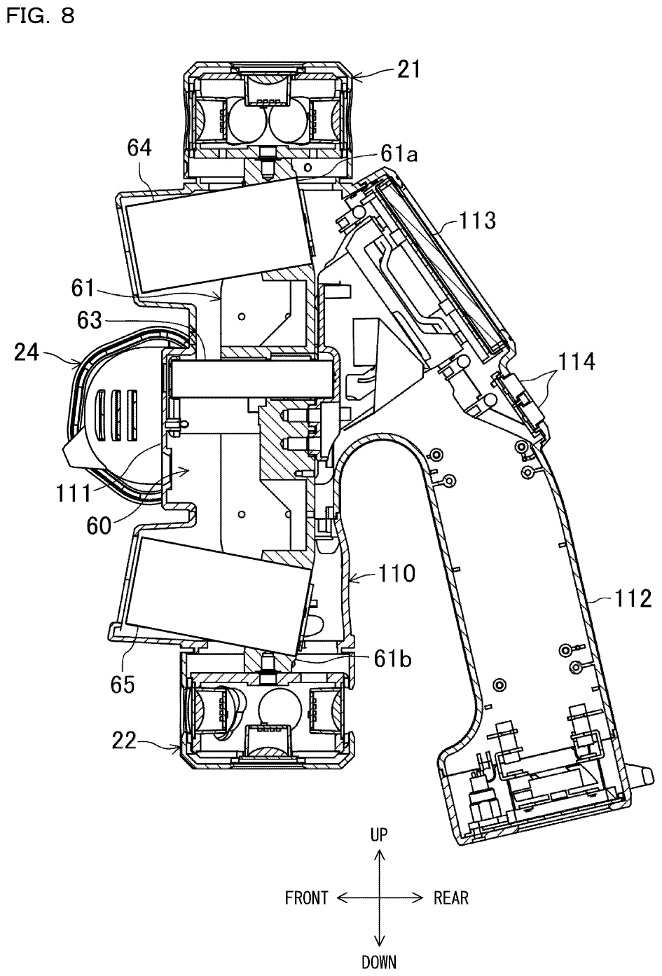

As illustrated in FIG. 8, the scanner body 20 includes a scanner unit 60 and an optical base 61. As illustrated in FIG. 7, the scanner unit 60 includes first scanner light sources 62, a second scanner light source 63, a first scanner imaging part 64, a second scanner imaging part 65, and a texture camera 66. As illustrated in FIG. 8, a part on the upper side of a central portion of the optical base 61 is a part constituting the first arm part 51, and is an upper support part 61a that supports the first marker block 21. Thus, the first marker block 21 is attached to an upper end of the upper support part 61a. A part on the lower side of the central portion of the optical base 61 is a part constituting the second arm part 52, and is a lower support part 61b that supports the second marker block 22. Thus, the second marker block 22 is attached to a lower end of the lower support part 61b.

Two first scanner light sources 62 (illustrated in FIG. 7) are attached to the central portion of the optical base 61 in the up-down direction, that is, the part between upper support part 61a and lower support part 61b at an interval in the left-right direction. The two first scanner light sources 62 are multi-line light sources each emitting a plurality of linear light beams in a measurement direction (forward), and are arranged such that light emission surfaces oppose the measurement target W at the time of measurement. The light emitted by the first scanner light source 62 can be referred to as multi-line light, and the multi-line light is included in pattern light.

The second scanner light source 63 is attached above the first scanner light source 62 in the central portion of the optical base 61 in the up-down direction. The second scanner light source 63 is a single-line light source that emits one linear light beam in the measurement direction (forward), and is arranged such that a light emission surface opposes the measurement target W at the time of measurement. The light emitted by the second scanner light source 63 can be referred to as single-line light, and the single-line light is also included in the pattern light.

Each of the first scanner light sources 62 and the second scanner light source 63 includes the laser light source that emits the laser light, but a type of the light source is not particularly limited. Further, a total of three scanner light sources 62 and 63 are provided in this example, but the invention is not limited thereto, and one or more scanner light sources may be provided. Further, a type of the pattern light is not particularly limited, and the scanner light source may emit pattern light other than the multi-line light and the single-line light.

The first scanner imaging part 64 and the second scanner imaging part 65 include, for example, a light receiving element such as a CMOS sensor, an optical system for forming an image of light incident from the outside on a light receiving surface of the light receiving element, and the like. The first scanner imaging part 64 is attached to an upper portion of the optical base 61 which is a portion spaced upward from the scanner light sources 62 and 63. The second scanner imaging part 65 is attached to a lower portion of the optical base 61 which is a portion spaced downward from the scanner light sources 62 and 63. The first scanner imaging part 64 and the second scanner imaging part 65 are arranged such that optical axes thereof are oriented in irradiation directions of beams of the pattern light from the scanner light sources 62 and 63, respectively, and accordingly, it is possible to capture images of beams of the pattern light emitted from the scanner light sources 62 and 63 in the measurement direction and generate the bright line image including the pattern light. The bright line image including the pattern light can also be referred to as a first image.

Since the first scanner imaging part 64 is attached to the upper portion of the optical base 61 and the second scanner imaging part 65 is attached to the lower portion of the optical base 61, it is possible to secure a long distance between the first scanner imaging part 64 and the second scanner imaging part 65 and to enhance accuracy of a stereo measurement method. That is, a distance between the optical axes of the first scanner imaging part 64 and the second scanner imaging part 65 is known, a corresponding point between the respective images generated by simultaneously capturing the pattern light emitted from the first scanner light source 62 or the second scanner light source 63 by the first scanner imaging part 64 and the second scanner imaging part 65 is obtained, and three-dimensional coordinates of the corresponding point can be obtained using the stereo measurement method. The stereo measurement method may be passive stereo using the first scanner imaging part 64 and the second scanner imaging part 65, or may be active stereo using one scanner imaging part. In particular, there is a case where the pattern light is not included in one of the images generated by the first scanner imaging part 64 and the second scanner imaging part 65, such as a case where the measurement target W is specularly reflected or a case where a deep hole is measured. In such a case, the three-dimensional coordinates may be calculated by an active stereo method based on a positional relationship between the scanner imaging part and the scanner light source corresponding to the image obtained by capturing the pattern light.

The texture camera 66 includes, for example, a light receiving element such as a CMOS sensor capable of acquiring a color image, an optical system for forming an image of light incident from the outside on a light receiving surface of the light receiving element, and the like. The texture camera 66 is attached to the optical base 61 between the first scanner imaging part 64 and the second scanner imaging part 65. The texture camera 66 is arranged such that an optical axis is oriented toward the measurement target W at the time of measurement, and captures an image of the measurement target W to generate a texture image.

The first to fourth marker blocks 21 to 24 have the same structure. The first marker block 21 includes the first to seventh self-luminous markers 71 to 77 facing a plurality of directions.

The second to fourth marker blocks 22 to 24 are configured similarly to the first marker block 21. That is, as illustrated in FIGS. 3 to 8, the second marker block 22 includes the first to seventh self-luminous markers 81 to 87, the third marker block 23 includes the first to seventh self-luminous markers 91 to 97, and the fourth marker block 24 includes the first to seventh self-luminous markers 101 to 107.

As illustrated in FIG. 7, the first self-luminous marker 71 of the first marker block 21 and the first self-luminous marker 81 of the second marker block 22 are arranged so as to be misaligned around the straight line B. The optical axis of the first self-luminous marker 71 of the first marker block 21 and an optical axis of the first self-luminous marker 81 of the second marker block 22 face different directions. This is because a plurality of side surfaces formed in the second marker block 22 are arranged such that positions about an axis extending in the first direction (the up-down direction) are shifted from those of a plurality of side surfaces formed in the first marker block 21. Similarly, a plurality of side surfaces formed on the fourth marker block 24 are arranged such that positions about an axis extending in the second direction (the left-right direction) are shifted from those of a plurality of side surfaces formed on the third marker block 23. This makes it difficult to obtain a plurality of solutions at the time of marker image processing to be described later.

The scanner body 20 includes an exterior member 110 made of resin that covers the optical base 61. A front part of the exterior member 110 includes a scanner cover part 111 that covers the first scanner light source 62, the second scanner light source 63, the first scanner imaging part 64, and the second scanner imaging part 65. Further, a rear part of the exterior member 110 has the grip part 112 to be gripped by the measurement worker.

For example, as illustrated in FIG. 8, the grip part 112 has a shape elongated in the up-down direction, and the upper end thereof is integrated with a body part of the exterior member 110, and is provided at a position distant from the optical base 61 toward the opposite side (the rear side) to the measurement direction.

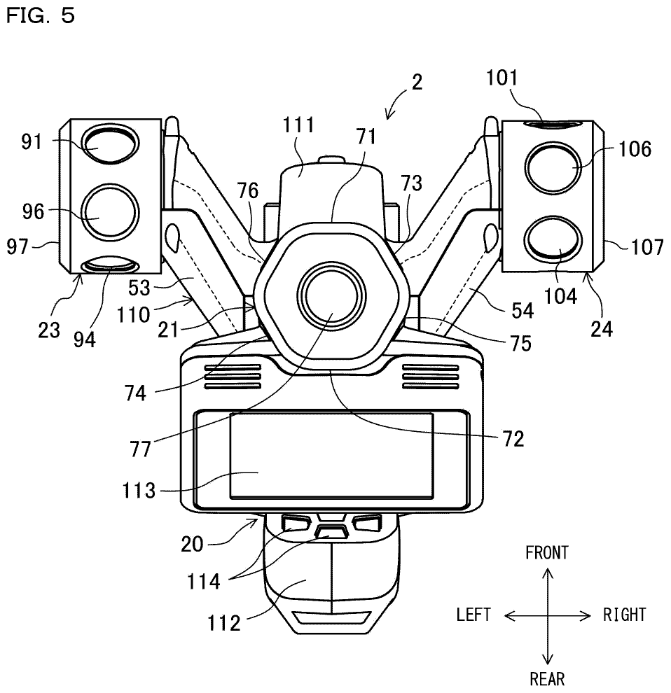

As illustrated in FIGS. 5 and 8, a scanner display unit 113 configured to display information regarding a measurement result obtained by the scanner unit 60, a setting screen, and the like and an operation unit 114 configured to operate the scanner unit 60 are provided at the upper end of the grip part 112. The scanner display unit 113 is configured by a liquid crystal display, an organic EL display, or the like, and is arranged such that a display surface is inclined. Further, the display surface is oriented toward a measurement subject such that the three-dimensional scanner 2 can be moved while viewing a display content of the scanner display unit 113. The scanner display unit 113 is a display unit incorporated in the three-dimensional scanner 2, the display unit being provided integrally with the three-dimensional scanner 2, and the display unit being undetachably attached to a body part of the three-dimensional scanner 2 during operation, and is a so-called built-in display unit. The scanner display unit 113 is provided above the grip part 112 and in the vicinity of a part where the grip part 112 and the scanner body 20 are connected. Further, the display surface of the scanner display unit 113 is embedded above the grip part 112 so as to be oriented in a direction oppositely to the orientation in which light is emitted from the scanner light sources 62 and 63. Further, as illustrated in FIG. 8, the periphery of the scanner display unit 113 is covered with the exterior member 110, and is arranged integrally and continuously with an exterior housing 110 that covers the grip part 112. Further, the operation unit 114 is also an operation unit incorporated in the three-dimensional scanner 2 similarly to the scanner display unit 113, and is a so-called built-in operation unit. The operation unit 114 is arranged below the scanner display unit 113, and the periphery of the operation unit 114 is covered with the exterior housing 110. Here, the exterior housing 110 is provided with protrusions and recessions corresponding to a shape of the operation unit 114, and the operation unit 114 is also covered with the exterior housing 110.

A touch panel 113a on which a touch operation can be performed is also provided on the display surface side of the scanner display unit 113. The operation unit 114 includes, for example, a plurality of operation buttons including a measurement start button, a measurement stop button, and the like, and is arranged below the scanner display unit 113. The touch panel 113a can also be a part of the operation unit.

### Circuit of Three-Dimensional Scanner 2

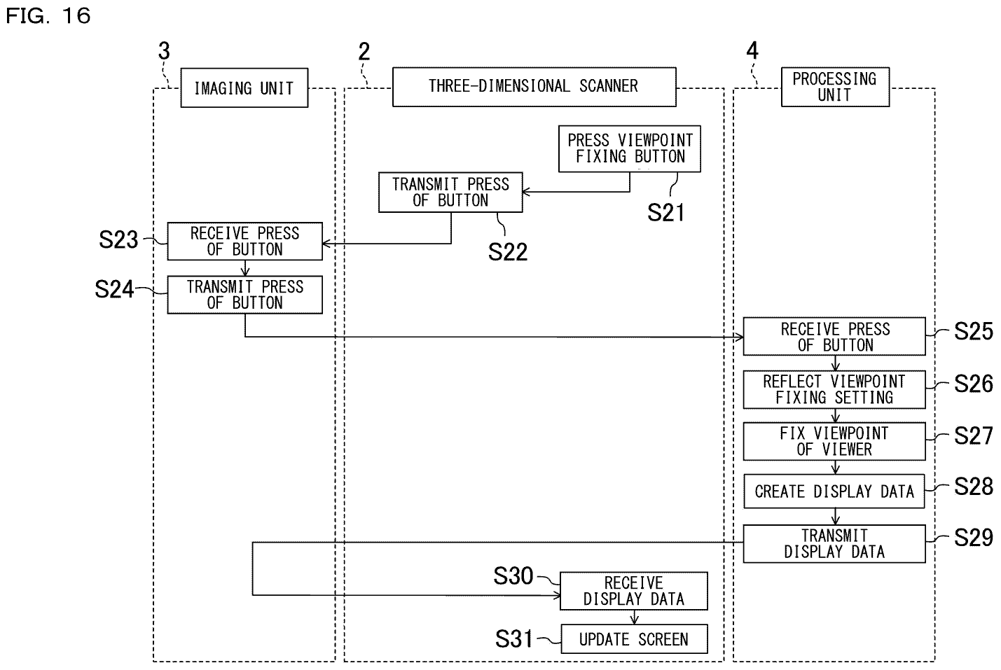

Next, a circuit of the three-dimensional scanner 2 will be described with reference to FIG. 16. The three-dimensional scanner 2 includes a display control part 140, a marker lighting control part 141, a scanner control part 142, and a storage unit 143. The display control part 140 is a part that controls the scanner display unit 113 based on a signal output from the scanner control part 142, and causes the scanner display unit 113 to display various images, a user interface, and the like. The user's operation performed on the scanner display unit 113 is acquired by the scanner control part 142 based on a signal output from the touch panel 113a.

The marker lighting control part 141 is a part that controls the self-luminous markers 71 to 77, 81 to 87, 91 to 97, and 101 to 107 (only 71 is illustrated in FIG. 16). The self-luminous markers 71 to 77, 81 to 87, 91 to 97, and 101 to 107 are switched between the turned-on state and the turned-off state by the marker lighting control part 141. The marker lighting control part 141 is controlled by the scanner control part 142. The storage unit 143 can temporarily store a program, an image captured by the scanner unit 60, and the like.

The three-dimensional scanner 2 includes a wireless communication unit (first communication unit) 144 that is controlled by the scanner control part 142. The wireless communication unit 144 is a communication module or the like configured to be capable of communicating with equipment other than the three-dimensional scanner 2. In this example, the three-dimensional scanner 2 communicates with the imaging unit 3 via the wireless communication unit 144, thereby enabling, for example, transmission and reception of various types of data such as image data captured by the scanner unit 60, various signals, and the like.

The three-dimensional scanner 2 includes a motion sensor 145. The motion sensor 145 includes a sensor that detects an acceleration and an angular velocity of the three-dimensional scanner 2, and detected values are output to the scanner control part 142 and used for various types of calculation processing. For example, a value output from the motion sensor 145 can be used to obtain an initial solution of the posture of the three-dimensional scanner 2, that is, the postures of the first to fourth marker blocks 21 to 24, thereby improving the matching accuracy and improving the processing speed at the time of posture calculation. The processing using the values output from the motion sensor 145 may be executed by the imaging unit 3 or the processing unit 4.

The three-dimensional scanner 2 includes a scanner light source control part 146 and the scanner image processing unit 147. The scanner light source control part 146 controls the first scanner light source 62 and the second scanner light source 63. The first scanner light source 62 and the second scanner light source 63 are switched between the turned-on state and the turned-off state by the scanner light source control part 146. The scanner light source control part 146 is controlled by the scanner control part 142. Further, the scanner image processing unit 147 controls the first scanner imaging part 64, the second scanner imaging part 65, and the texture camera 66 to execute imaging at a predetermined timing. Images captured by the first scanner imaging part 64, the second scanner imaging part 65, and the texture camera 66 are input to the scanner image processing unit 147. The scanner image processing unit 147 executes various types of image processing such as extraction of edge data on the input images.

That is, the scanner image processing unit 147 generates edge data (corresponding to first measurement information of the invention) by performing edge extraction processing on the bright line image generated by the first scanner imaging part 64 or the second scanner imaging part 65. In a case where the first scanner light sources 62 emit the multi-line light, the first scanner imaging part 64 and the second scanner imaging part 65 generate multi-line images. The scanner image processing unit 147 processes the multi-line images to generate the edge data.

The wireless communication unit 144 transmits the edge data generated by the scanner image processing unit 147 and identification information corresponding to the edge data generated by the trigger generation unit 38 to be tied to each other. That is, the edge data and the identification information for distinguishing the edge data from another edge data are linked to each other. Therefore, it is possible to specify desired edge data based on the identification information. The wireless communication unit 144 corresponds to a first transmission unit of the invention. The edge data and the identification information may be transmitted by wired communication.

Further, when the trigger generated by the trigger generation unit 38 of the imaging unit 3 is transmitted to the three-dimensional scanner 2, the scanner control part 142 receives the trigger via the three-dimensional scanner 2. When the scanner control part 142 receives the trigger, the scanner light source control part 146 executes emission of pattern light from the first scanner light source 62 or the second scanner light source 63, the scanner image processing unit 147 executes imaging by the first scanner imaging part 64 and the second scanner imaging part 65, and the marker lighting control part 141 causes the self-luminous markers 71 to 77, 81 to 87, 91 to 97, and 101 to 107 to emit light. The irradiation of pattern light from the first scanner light source 62 or the second scanner light source 63, the imaging by the first scanner imaging part 64 and the second scanner imaging part 65, and the light emission of the self-luminous markers 71 to 77, 81 to 87, 91 to 97, and 101 to 107 are synchronized with each other.

In short, the body control part 33 of the imaging unit 3 and the scanner control part 142 of the three-dimensional scanner 2 cooperate to synchronize the irradiation of pattern light from the scanner light source 62 or 63, the imaging by the scanner imaging parts 64 and 65, the light emission of the self-luminous markers 71 to 77, 81 to 87, 91 to 97, and 101 to 107, and the imaging by the movable imaging part 3A in response to the generation of the trigger by the trigger generation unit 38.

The three-dimensional scanner 2 includes an indicator lamp 148 and the communication control part 149. The indicator lamp 148 displays an operation state of the three-dimensional scanner 2, and is controlled by the scanner control part 142. The communication control part 149 is a part that performs processing of executing communication of, for example, image data and the like.

### Three-Dimensional Data Generation Unit

The processing unit 4 illustrated in FIG. 2 includes a three-dimensional data generation mechanism that generates a point cloud indicating the three-dimensional shape of the measurement target W based on the edge data generated by the scanner image processing unit 147, the center position information of each of the self-luminous markers generated by the camera image processing unit 35, and the position and posture information of the scanner imaging camera 32. Point cloud data indicating the three-dimensional shape of the measurement target W is an example of display data indicating the three-dimensional shape of the measurement target W.

Specifically, the processing unit 4 includes a three-dimensional data generation unit 43a. When imaging is executed by the three-dimensional scanner 2 and the imaging unit 3, the processing unit 4 receives edge data generated by the scanner image processing unit 147 of the three-dimensional scanner 2, identification information corresponding to the edge data, center position information of each of the self-luminous markers generated by the camera image processing unit 35 of the imaging unit 3, and identification information corresponding to the center position information of each of the self-luminous markers. After pieces of the data and the information are received, the three-dimensional data generation unit 43a generates the point cloud data indicating the three-dimensional shape of the measurement target W based on the received edge data, the identification information corresponding to the edge data, the center position information of each of the self-luminous markers, and the identification information corresponding to the center position information of each of the self-luminous markers.

In this example, as illustrated in FIG. 2, the imaging unit 3 includes a memory 39a that sequentially accumulates pieces of the edge data generated by the scanner image processing unit 147, and an association unit 39b that associates pieces of the edge data with pieces of the center position information of the self-luminous markers based on identification information. For example, in a case of sequentially measuring a plurality of the measurement targets W or in a case of sequentially measuring different portions of the same measurement target W, the scanner image processing unit 147 generates a plurality of pieces of the edge data. The plurality of pieces of generated edge data are transmitted from the wireless communication unit 144 of the three-dimensional scanner 2 to the imaging unit 3 with mutually different pieces of identification information being tied thereto. The plurality of pieces of edge data transmitted from the wireless communication unit 144 of the three-dimensional scanner 2 are accumulated in the memory 39a of the imaging unit 3 with pieces of the identification information being tied thereto.

When the three-dimensional data generation unit 43a is caused to generate the point cloud indicating the three-dimensional shape, the association unit 39b specifies center position information of a self-luminous marker transmitted to the processing unit 4. The association unit 39b specifies edge data having the identification information tied to the specified center position information of the self-luminous marker from among the plurality of pieces of edge data accumulated in the memory 39a. Thereafter, the association unit 39b associates the specified edge data with the center position information of the self-luminous marker. The communication unit 37 of the imaging unit 3 transmits the edge data specified by the association unit 39b and the center position information of the self-luminous marker in association with each other to the processing unit 4. That is, a processing content is different between the generation of the center position information of the self-luminous marker and the generation of the edge data, and thus, there is a case where a timing at which the processing ends is different therebetween. However, the synchronization based on the trigger ID as in this example enables generation of the point cloud indicating the three-dimensional shape between corresponding ones regardless of a difference between the timings at which the processing ends.

### Setting

As illustrated in FIG. 2, the processing unit 4 includes a measurement setting unit 48 that receives a setting of at least one of a type of pattern light emitted from the scanner light sources 62 and 63 of the three-dimensional scanner 2 and an exposure time of the scanner imaging parts 64 and 65. The types of pattern light include multi-line light and single-line light. The setting of the type of pattern light and the exposure time can be received via a setting screen to be described later, and such setting processing will be described later.

The control part 43 of the processing unit 4 is a measurement control part that controls the scanner light sources 62 and 63 or the scanner imaging parts 64 and 65 based on the setting received by the measurement setting unit 48. When the setting of the multi-line light is received by the measurement setting unit 48, information (setting information) indicating that the multi-line light is set is written in the measurement setting unit 48. Further, when the single-line light is set, information (setting information) indicating that the single-line light is set is written in the measurement setting unit 48. Further, when the exposure time is set, the set exposure time (setting information) is written in the measurement setting unit 48.

The control part 43 controls the scanner light sources 62 and 63 or the scanner imaging parts 64 and 65 based on the setting information written in the measurement setting unit 48. For example, when the multi-line light is set, when the control part 43 reads the information indicating that the multi-line light is set from the measurement setting unit 48, the read setting information is transmitted to the three-dimensional scanner 2 via the communication unit 46. The scanner light source control part 146 of the three-dimensional scanner 2 controls the first scanner light source 62 such that the multi-line light is emitted. When the single-line light is set, the scanner light source control part 146 of the three-dimensional scanner 2 controls the second scanner light source 63 such that the single-line light is emitted.

Further, in the setting of the exposure time, the control part 43 reads the set exposure time from the measurement setting unit 48. The control part 43 transmits the read exposure time to the three-dimensional scanner 2 via the communication unit 46. The scanner image processing unit 147 of the three-dimensional scanner 2 controls the scanner imaging parts 64 and 65 so as to satisfy the set exposure time.

### Display Processing of Scanner Display Unit 113

Next, display processing of the scanner display unit 113 included in the three-dimensional scanner 2 will be described. When display data indicating the three-dimensional shape of the measurement target W is generated, the processing unit 4 transmits the generated display data through the communication unit (corresponding to a second communication unit of the invention) 46. The wireless communication unit 144 of the three-dimensional scanner 2 receives the display data transmitted via the communication unit 46 of the processing unit 4. The scanner display unit 113 displays a display screen generated based on the display data received via the wireless communication unit 144. Note that, when the three-dimensional scanner 2 is connected to the imaging unit 3 or the processing unit 4 via a communication cable, the scanner display unit 113 may display the display screen generated based on the display data received via the communication control part 149. A case where the three-dimensional scanner 2 wirelessly communicates with at least one of the imaging unit 3 and the processing unit 4 will be mainly described, but wired communication via a communication cable may be used.

As a more specific form, the processing unit 4 receives the edge data generated by the scanner image processing unit 147 of the three-dimensional scanner 2 and transmitted via the wireless communication unit 144 and the center position information of the self-luminous markers 71 to 77, 81 to 87, 91 to 97, and 101 to 107 generated by the camera image processing unit 35 of the imaging unit 3 and transmitted via the wireless communication unit 36, and generates the display data indicating the three-dimensional shape of the measurement target W based on the received edge data and the center position information of the self-luminous markers 71 to 77, 81 to 87, 91 to 97, and 101 to 107. The display data is generated every time imaging is completed, and the processing unit 4 transmits the generated display data to the three-dimensional scanner 2.

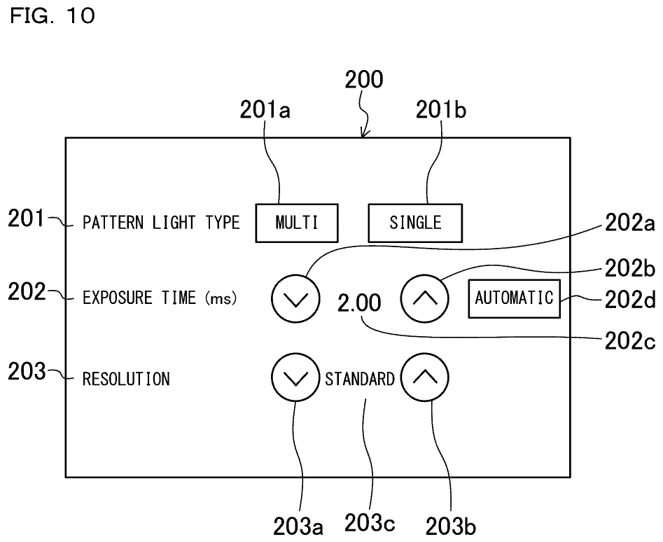

Further, the scanner display unit 113 displays a setting screen 200 (FIG. 10) that receives the setting of at least one of the type of pattern light emitted by the scanner light sources 62 and 63 and the exposure time of the scanner imaging parts 64 and 65 described above. The setting screen 200 is a screen serving as a so-called user interface, and is generated by the display control part 140, the scanner control part 142, and the like of the three-dimensional scanner 2 and displayed on the scanner display unit 113. Information necessary for generating the setting screen 200 may be transmitted from the processing unit 4 or may be generated by the imaging unit 3.

The setting screen 200 is provided with a pattern light setting area 201 for setting the type of pattern light, an exposure time setting area 202 for setting the exposure time, and a resolution setting area 203 for setting the resolution. A pattern light setting area 201 is provided with a first button 201a for setting the multi-line light and a second button 201b for setting the single-line light. When the measurement worker presses the first button 201a, the touch panel 113a detects that the first button 201a has been pressed, the first button 201a is displayed in a form in which the pressing can be discerned, and the scanner control part 142 transmits the detected result to the processing unit 4. The control part 43 of the processing unit 4 that has received the detected result writes information indicating that the multi-line light has been set in the measurement setting unit 48. Further, the scanner control part 142 determines whether the current setting is the multi-line light, and controls the first scanner light source unit 62 such that the multi-line light is emitted from the first scanner light source unit 62 when the current setting is not the multi-line light. Similarly, when the second button 201b is pressed, the second button 201b is displayed in a form in which the pressing can be discerned, and the scanner control part 142 transmits the detected result to the processing unit 4. The control part 43 of the processing unit 4 that has received the detected result writes information indicating that the single-line light has been set in the measurement setting unit 48. Further, the scanner control part 142 determines whether the current setting is the single-line light, and controls the second scanner light source unit 63 such that the single-line light is emitted from the second scanner light source unit 63 when the current setting is not the single-line light.

The exposure time setting area 202 is provided with a decrease button 202a that is operated to shorten the exposure time, an increase button 202b that is operated to lengthen the exposure time is lengthened, and an exposure time display section 202c displaying the set exposure time in a numerical value. The measurement worker can easily set a desired exposure time by operating the increase button 202b to the decrease button 202a while viewing the exposure time displayed on the exposure time display section 202c. The scanner control part 142 transmits the set exposure time to the processing unit 4. The control part 43 of the processing unit 4 that has received the exposure time writes the exposure time into the measurement setting unit 48. Further, the scanner control part 142 controls the scanner imaging parts 64 and 65 based on the set exposure time. Further, an automatic button 202d may be provided, and the three-dimensional measurement device 1 executes processing of automatically obtaining an optimum exposure time when the automatic button 202d is operated, and the obtained exposure time is automatically set.

A resolution setting area 203 is provided with a resolution reducing button 203a that is operated to increase the amount of thinning at the time of point cloud generation and reduce the resolution, a resolution increasing button 203b that is operated to decrease the amount of thinning and increase the resolution at the time of point cloud generation, and a resolution display section 203c displaying the set resolution. The measurement worker can set a desired resolution by operating the resolution reducing button 203a to the resolution increasing button 203b. The scanner light source control part 146 transmits the set resolution to the processing unit 4. The control part 43 of the processing unit 4 that has received the resolution writes the resolution into the measurement setting unit 48. The three-dimensional data generation unit 43a generates a point cloud so as to have the resolution written in the measurement setting unit 48. The resolution can be set in stages such as “high resolution”, “standard”, and “low resolution”.

In this manner, on the setting screen 200 as illustrated in FIG. 10, both a setting for the three-dimensional scanner 2 and a setting for the processing unit 4 can be set. Here, in a case where the setting for the three-dimensional scanner 2 has been performed, the scanner control part 142 controls at least one of the scanner imaging parts 64 and 65 and the scanner light sources 62 and 63 based on the setting information received on the setting screen 200. Further, the setting information of the three-dimensional scanner 2 received on the setting screen 200 is also transmitted to the processing unit 4 and used at the time of point cloud generation. Further, in a case where the setting for the processing unit 4 has been performed on the setting screen 200, the scanner control part 142 transmits the setting information received on the setting screen 200 to the processing unit 4. That is, setting items set on the setting screen 200 may include a setting item for controlling the operation of the three-dimensional scanner 2 and transferring the setting item to the processing unit, and a setting item for transferring the setting item to the processing unit without controlling the operation of the three-dimensional scanner 2.

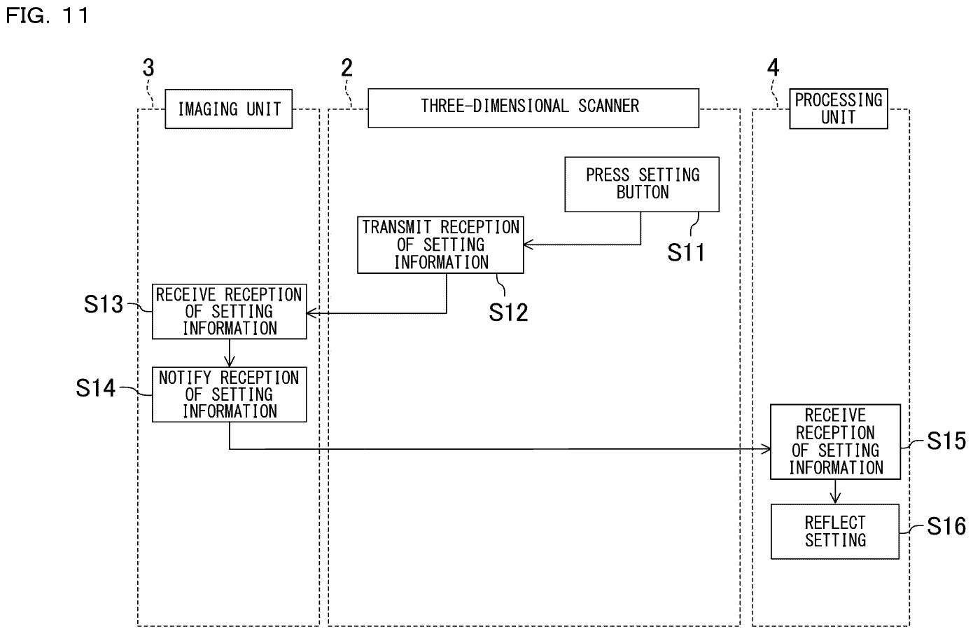

An example of a procedure for reflecting the above-described setting information will be described with reference to FIG. 11. In Step S11, pressing (operation) of a setting button is detected. Examples of the setting button include a first button 201a, a second button 201b, a decrease button 202a, and an increase button 202b illustrated in FIG. 10. In Step S12, the fact that the setting button has been pressed and the setting information has been received (including the setting information) is transmitted to the imaging unit 3. In Step S13, the imaging unit 3 receives that the setting information has been received. In Step S14, the imaging unit 3 transmits that the setting information has been received to the processing unit 4. In Step S15, the processing unit 4 receives that the setting information has been received. In Step S16, the setting information is reflected.

### Display on Scanner Display Unit

The three-dimensional data generation unit 43a of the processing unit 4 illustrated in FIG. 2 generates new display data indicating a three-dimensional shape of the measurement target W based on a new image including pattern light generated by the scanner imaging parts 64 and 65 controlled based on setting information written in the measurement setting unit 48 and a position and a posture of the three-dimensional scanner 2 specified by the imaging unit 3. That is, when the setting operation described above is performed by the measurement worker so that the exposure time is changed, the scanner imaging parts 64 and 65 are controlled so as to satisfy the exposure time after the change, and thus the new image different from an image generated before the change is generated. The display data generated based on the new image and the position and posture of the three-dimensional scanner 2 is different from display data before the change. Therefore, the processing unit 4 transmits the new display data after the change of the exposure time to the three-dimensional scanner 2. As a result, the scanner display unit 113 can display a display screen generated based on the new display data transmitted from the processing unit 4, and thus the measurement worker can determine whether the exposure time after the change is appropriate only by viewing the scanner display unit 113 of the three-dimensional scanner 2. Similarly, also in the setting of the pattern light, it can be determined whether the pattern light after the change is appropriate.

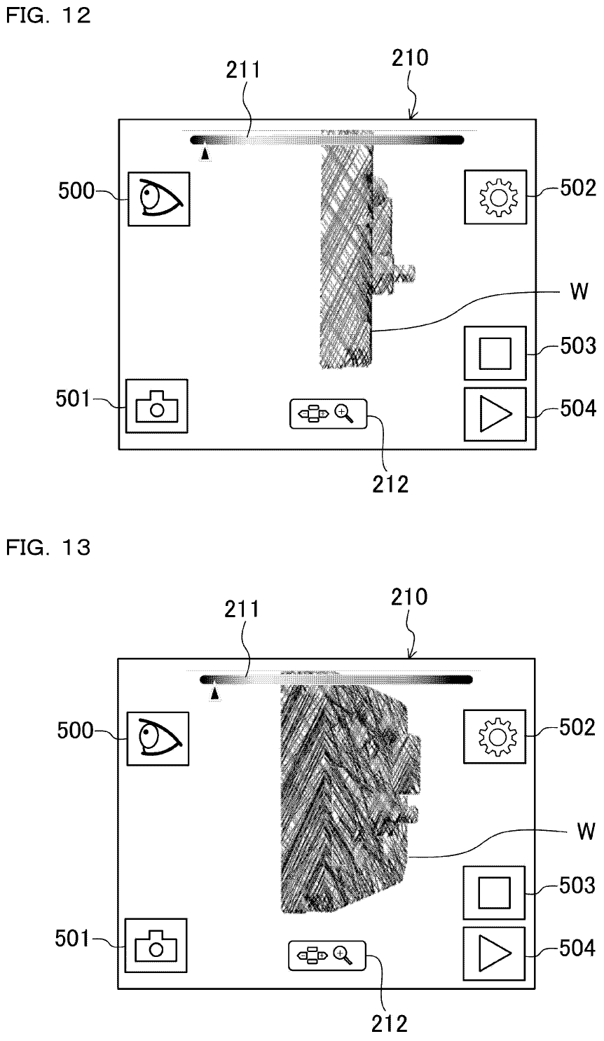

FIG. 12 is a view illustrating a first example of a shape display screen 210 displaying a point cloud indicating a three-dimensional shape of the measurement target W. FIG. 12 illustrates an example in which the point cloud is illustrated as measurement results of the measurement target W irradiated with multi-line light sources. The scanner display unit 113 can display the shape display screen 210 having a display area 211 of distance information representing a distance between the measurement target W and the three-dimensional scanner 2. The distance between the measurement target W and the three-dimensional scanner 2 can also be referred to as a working distance, and thus the display area 211 of the distance information is also a working distance display area.

The shape display screen 210 is provided with a viewpoint fixing button 500, a texture capturing button 501, a setting button 502, a scan stop button 503, and a scan start button 504. The viewpoint fixing button 500 is a button that is operated to fix a viewpoint of an image displayed on the shape display screen 210. The texture capturing button 501 is a button that is operated to acquire the texture image using the texture camera 66, and when the texture capturing button 501 is operated, a trigger signal for texture acquisition is generated. The setting button 502 is a button that is operated to perform various settings, and when the setting button 502 is operated, a setting screen (not illustrated) is displayed and various setting operations can be received. The scan stop button 503 is a button that is operated to stop scanning by the three-dimensional scanner 2. The scan start button 504 is a button that is operated to start scanning by the three-dimensional scanner 2.

In the display area 211 of the distance information, whether the distance between the measurement target W and the three-dimensional scanner 2 is relatively short or long may be displayed, or the distance may be displayed as a numerical value. In this example, the distance between the measurement target W and the three-dimensional scanner 2 is displayed in a color bar format. Further, the shape display screen 210 is also provided with a scale changer 212. When the measurement worker operates the scale changer 212, the displayed three-dimensional shape of the measurement target W is enlarged or reduced.

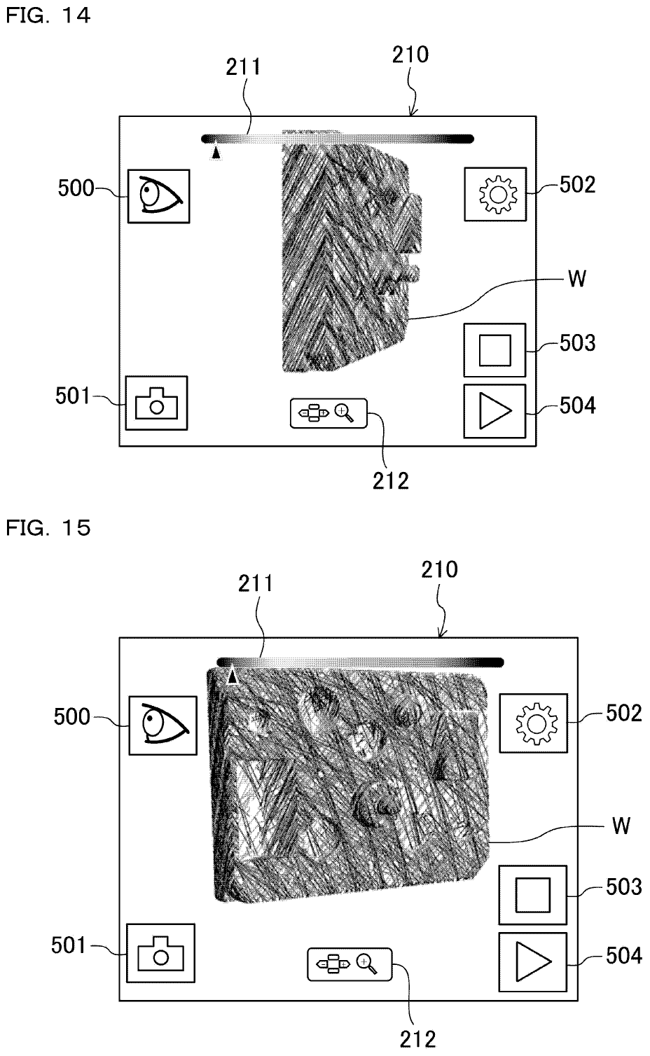

FIGS. 13 and 14 illustrate a second example and a third example of the shape display screen 210 displaying point clouds indicating the three-dimensional shape of the measurement target W, and view, in another angle, a case where the same measurement target W illustrated in FIG. 12 is measured a plurality of times. In this manner, it can be seen that the number of point clouds to be obtained increases as the number of times of measurement of the same measurement target W increases, and it is also possible to grasp where portions (white portions in the measurement target W) that have not been measured is. FIG. 15 illustrates a fourth example of the shape display screen 210 displaying point clouds indicating the three-dimensional shape of the measurement target W. It can be seen that, as the number of times of measurement is further increased, the obtained point clouds become dense, and the number of the portions that have not been measured decreases. Therefore, the measurement worker can easily confirm matters, such as whether the working distance is appropriate, whether a portion desired to be measured in the measurement target W has been irradiated with the pattern light, and how much a current scan completion range is, only by viewing the scanner display unit 113. The shape display screen 210 can also be referred to as an image indicating a measurement range of the three-dimensional scanner 2 or an image indicating a measurement completion region of the three-dimensional scanner 2.

The point cloud indicating the three-dimensional shape of the measurement target W can be displayed on the scanner display unit 113 in a state where the viewpoint is fixed. Processing in the case of fixing the viewpoint will be described with reference to FIG. 16. In Step S21, it is detected that a viewpoint fixing button included in the operation unit 114 of the three-dimensional scanner 2 has been pressed. In Step S22, the fact that the viewpoint fixing button has been pressed is transmitted to the imaging unit 3. In Step S23, the imaging unit 3 receives that the viewpoint fixing button has been pressed. In Step S24, the imaging unit 3 transmits that the viewpoint fixing button has been pressed to the processing unit 4. In Step S25, the processing unit 4 receives that the viewpoint fixing button has been pressed. In Step S26, a setting for fixing the viewpoint is reflected.

In Step S27, a state where the viewpoint of a viewer is fixed is obtained. In Step S28, display data is created in the state where the viewpoint of the viewer is fixed. In Step S29, the display data created in Step S28 is transmitted to the three-dimensional scanner 2 via the imaging unit 3. In Step S30, the three-dimensional scanner 2 receives the display data. In Step S31, the screen displayed on the scanner display unit 113 is updated based on the display data received in Step S30.

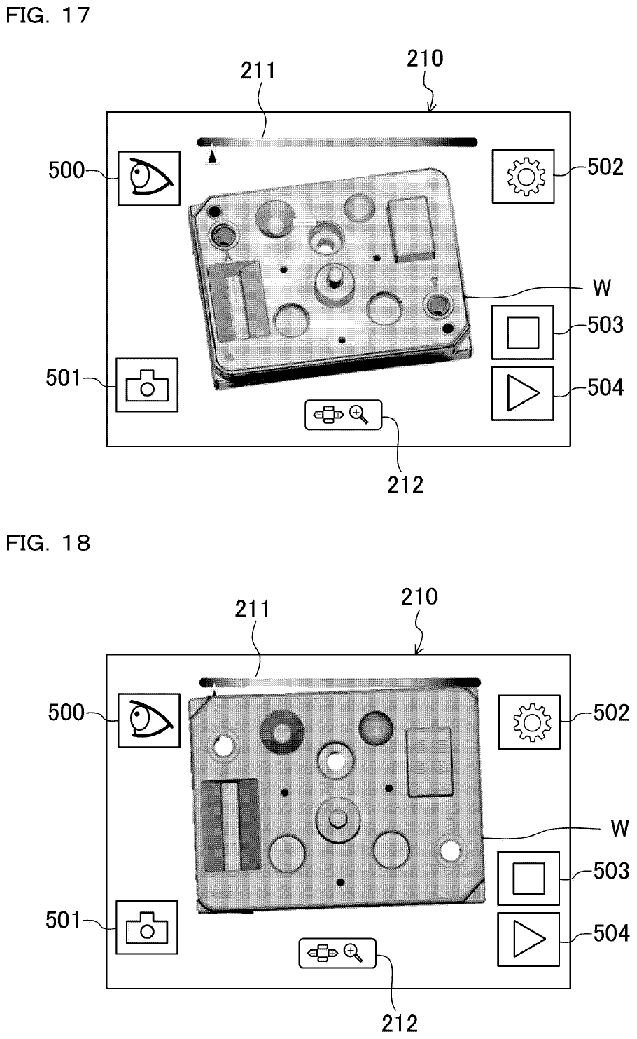

FIG. 17 illustrates an example of the display screen 210 showing difference information representing a difference between CAD data of the measurement target W and the three-dimensional shape of the measurement target W generated by the three-dimensional data generation unit 43a. The CAD data of the measurement target W can be input to the processing unit 4 from the outside. The control part 43 calculates a difference between the CAD data and three-dimensional shape data after matching an origin on the CAD data with an origin of the three-dimensional shape data generated by the three-dimensional data generation unit 43a. The display screen 210 can display the difference information between the CAD data and the three-dimensional shape data in a heat map format. For example, in FIG. 17, the display can be performed to be brighter as the difference is larger, or conversely, the display can be performed to be darker as the difference is larger. That is, since the scanner display unit 113 can display the display screen 210 showing the difference information representing the difference between the CAD data and the three-dimensional shape data obtained by the measurement, the measurement worker can confirm the difference information on the three-dimensional scanner 2.

FIG. 18 is a view illustrating an example of the display screen 210 in a case where texture of the measurement target W is reflected. The texture of the measurement target W can be acquired as a texture image (color image) by the texture camera 66 of the three-dimensional scanner 2. The texture image is transmitted to the processing unit 4. The control part 43 of the processing unit 4 generates superimposition display data for superimposing and displaying the texture image on a point cloud indicating the three-dimensional shape of the measurement target W generated based on display data. For example, the control part 43 can generate the superimposition display data by matching an origin of the texture image with an origin of three-dimensional shape data generated by the three-dimensional data generation unit 43a and superimposing the texture image on the three-dimensional shape data. The generated superimposition display data is transmitted to the three-dimensional scanner 2 and displayed on the scanner display unit 113. That is, the scanner display unit 113 displays the display screen 210 in which the color image of the measurement target generated by the texture camera 66 is superimposed and displayed on the point cloud indicating the three-dimensional shape of the measurement target W generated based on the display data.

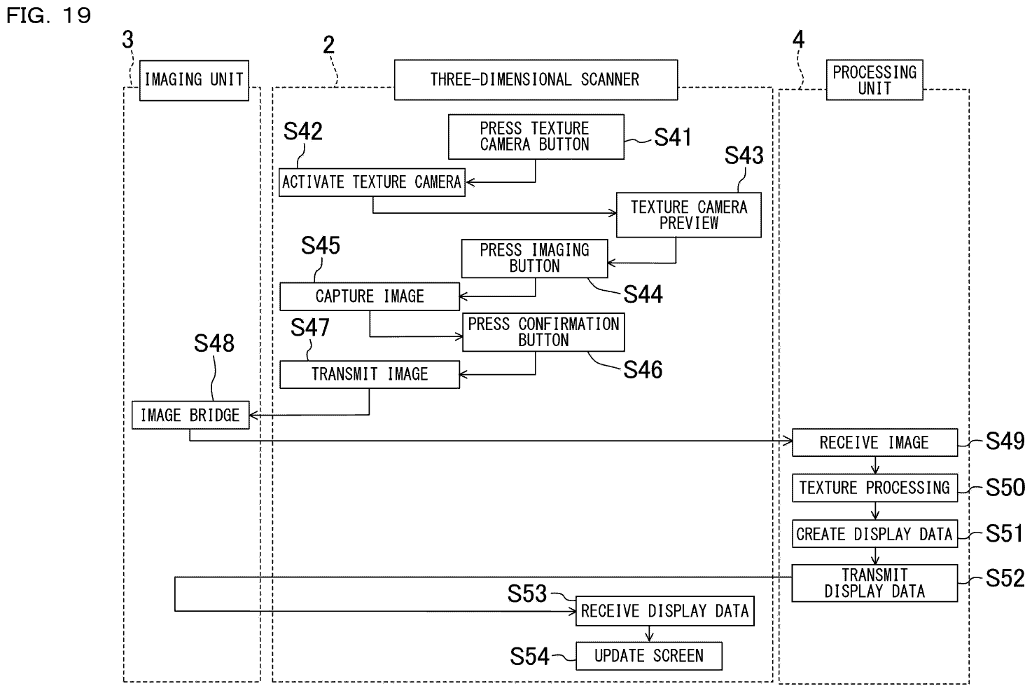

FIG. 19 is a flowchart illustrating an example of a procedure of processing for reflecting the texture. In Step S41, it is detected that a texture camera button included in the operation unit 114 of the three-dimensional scanner 2 has been pressed. In Step S42, the texture camera 66 is activated. In Step S43, a texture camera preview, that is, an image captured by the texture camera 66 is displayed on the scanner display unit 113. In Step S44, it is detected that an imaging button included in the operation unit 114 has been pressed. In Step S45, the image captured by the texture camera 66 when the imaging button has been pressed is captured. In Step S46, it is detected that a confirmation button (included in the operation unit 114) for confirming the image captured by the texture camera 66 is pressed.

In Step S47, the confirmed texture image is transmitted to the imaging unit 3. In Step S48, the imaging unit 3 performs image bridge processing as a bridge of the image to the processing unit, and transmits the processed texture image to the processing unit 4. In Step S49, the processing unit 4 receives the texture image. In Step S50, processing of superimposing and displaying the texture image received in Step S49 on the point cloud indicating the three-dimensional shape of the measurement target generated based on the display data, that is, texture processing is executed. In Step S51, display data subjected to the texture processing is created. In Step S52, the display data created in Step S51 is transmitted to the three-dimensional scanner 2 via the imaging unit 3. In Step S53, the three-dimensional scanner 2 receives the display data. In Step S54, the screen displayed on the scanner display unit 113 is updated based on the display data received in Step S53.

### Measurement by Three-Dimensional Measurement Device 1

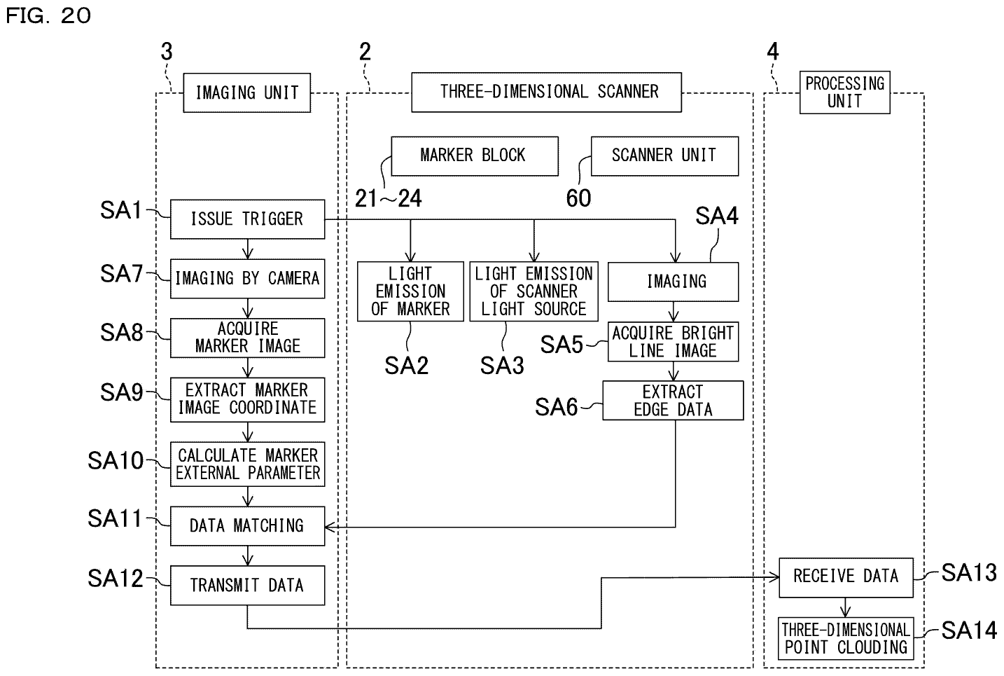

Next, a procedure of three-dimensional shape measurement of the measurement target W by the three-dimensional measurement device 1 configured as described above will be described with reference to a flowchart illustrated in FIG. 20. The measurement worker holds the grip part 112 of the three-dimensional scanner 2 and orients the scanner unit 60 toward the measurement target W, and then, operates the measurement start button included in the operation unit 114. Then, the imaging unit 3 issues a trigger in Step SA1. An ID is assigned to the trigger. The trigger issued by the imaging unit 3 is received by the wireless communication unit 144 of the three-dimensional scanner 2 via the wireless communication unit 36 of the imaging unit 3. Then, in Step SA2, the scanner control part 142 of the three-dimensional scanner 2 outputs a light emission instruction to the marker lighting control part 141, and the marker lighting control part 141 causes the self-luminous markers 71 to 77, 81 to 87, 91 to 97, and 101 to 107 to emit light. In Step SA3, the scanner control part 142 of the three-dimensional scanner 2 outputs a light emission instruction to the scanner light source control part 146, and the scanner light source control part 146 causes the first scanner light source 62 or the second scanner light source 63 to emit light. Which of the first scanner light source 62 and the second scanner light source 63 is caused to emit light is based on the setting information.

Further, in Step SA4, at the same time as Step SA3, the scanner control part 142 of the three-dimensional scanner 2 outputs an imaging instruction to the scanner image processing unit 147, and the scanner image processing unit 147 causes the first scanner imaging part 64 and the second scanner imaging part 65 to execute imaging. The exposure time of the first scanner imaging part 64 and the second scanner imaging part 65 is set based on the setting information. In Step SA5, a bright line image is acquired by the imaging by the first scanner imaging part 64 and the second scanner imaging part 65. A trigger ID is assigned to a luminance image. In Step SA6, the bright line image is input to the scanner image processing unit 147, and the scanner image processing unit 147 extracts edge data with respect to the bright line image. The edge data is received by the wireless communication unit 36 of the imaging unit 3 via the wireless communication unit 144 of the three-dimensional scanner 2.

Meanwhile, in the imaging unit 3, after the trigger is issued in Step SA1, the processing proceeds to Step SA7, the body control part 33 outputs an imaging instruction to the camera image processing unit 35, and the camera image processing unit 35 causes the scanner imaging camera 32 to execute imaging. In Step SA8, the scanner imaging camera 32 can acquire a marker image including a plurality of self-luminous markers. Note that a trigger ID is assigned to the marker image.

In Step SA9, the marker image is input to the camera image processing unit 35 of the imaging unit 3, and the camera image processing unit 35 extracts a marker image coordinate. In Step SA10, a marker external parameter is calculated. The marker external parameter is a six-axis parameter. In Step SA10, data matching between the edge data transmitted from the three-dimensional scanner 2 and the marker image coordinate is executed based on the trigger ID. Details of the data matching will be described later.

In Step SA12, data obtained in Step SA11 is transmitted to the communication unit 46 of the processing unit 4 via the communication unit 37. In Step SA13, the control part 43 of the processing unit 4 processes the data transmitted from the imaging unit 3. In Step SA14, the control part 43 generates a three-dimensional point cloud. As a result, a three-dimensional shape of the measurement target W is obtained.

### Details of Data Matching

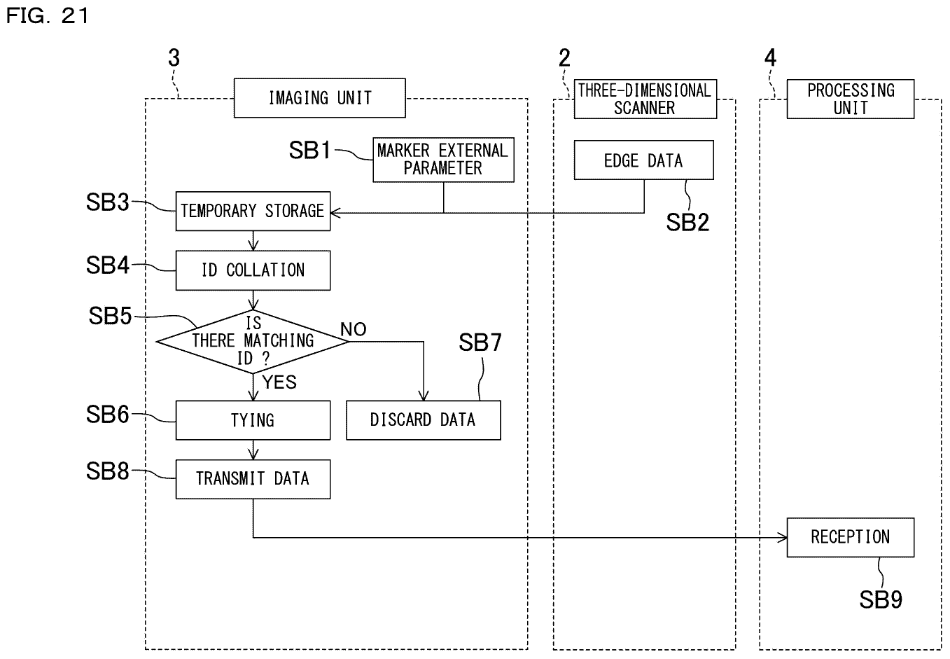

FIG. 21 is a flowchart illustrating an example of a procedure of data matching processing. In Step SB1, the imaging unit 3 acquires data of the marker external parameter calculated in Step SA10 of the flowchart illustrated in FIG. 20. Further, in Step SB2, the three-dimensional scanner 2 acquires the edge data extracted in Step SA6 of the flowchart illustrated in FIG. 20, and transmits the edge data to the imaging unit 3. In Step SB3, the imaging unit 3 temporarily stores the marker external parameter data acquired in Step SB1 and the edge data acquired in Step SB2.

In Step SB4, ID collation between the marker external parameter data and the edge data is executed based on the trigger IDs assigned in advance. In Step SB5, it is determined whether the trigger IDs match. If the trigger IDs match, the marker external parameter data is tied to the edge data in Step SB6. If the trigger IDs do not match, the marker external parameter data and the edge data are discarded in Step SB7. After Step SB6, data transmission processing with respect to the processing unit 4 is executed in Step SB8. In Step SB9, the processing unit 4 receives the data.

### Generation of Texture Image

When the three-dimensional scanner 2 receives a trigger signal for texture acquisition by the communication control part 149, the scanner control part 142 can control the texture camera 66 to execute imaging. Note that the trigger signal may be distinguished between a trigger signal for three-dimensional shape measurement and the trigger signal for texture acquisition, and a part or all thereof may be shared. The trigger signal for three-dimensional shape measurement and the trigger signal for texture acquisition may be distinguished from each other, and by sharing a part or all of them, it is possible to enhance synchronization between the imaging by the scanner imaging parts 64 and 65 and the imaging by the texture camera 66. Further, the trigger signal for texture acquisition may be generated by the trigger generation unit 38 of the imaging unit 3 according to an operation signal received by the operation input unit 42 of the processing unit 4.

When the trigger signal for texture acquisition is generated, the reference camera 34 captures images of the light emitting bodies 31b. Then, the camera image processing unit 35 acquires pieces of the arrangement information of the light emitting bodies 31b stored in the storage unit 39c of the imaging unit 3, processes the images of the light emitting bodies 31b generated by the reference camera 34 based on pieces of the arrangement information of the light emitting bodies 31b, and generates the position and posture information of the scanner imaging camera 32 with respect to the reference camera 34.

The scanner imaging camera 32 generates a marker image including the self-luminous markers 71 to 77, 81 to 87, 91 to 97, and 101 to 107 of the three-dimensional scanner 2. Further, the reference camera 34 captures images of a plurality of the light emitting bodies 31b provided in the movable imaging part 3A and generates an image including the light emitting bodies 31b. Then, the camera image processing unit 35 of the imaging unit 3 calculates position and posture information of the three-dimensional scanner 2 with the scanner imaging camera 32 as a reference based on the marker image including the self-luminous markers 71 to 77, 81 to 87, 91 to 97, and 101 to 107 and pieces of the arrangement information of the self-luminous markers 71 to 77, 81 to 87, 91 to 97, and 101 to 107 acquired from the storage unit 143 of the three-dimensional scanner 2. Further, thus, the position and posture of the three-dimensional scanner 2 with the reference camera 34 as the reference are calculated.

Further, the texture camera 66 of the three-dimensional scanner 2 is controlled in synchronization with the generation of the trigger signal for texture acquisition, thereby generating a texture image. The texture image generated here is obtained with the texture camera 66 as a reference. Since the positional relationship between the texture camera 66 of the three-dimensional scanner 2 and the self-luminous markers 71 to 77, 81 to 87, 91 to 97, and 101 to 107 is known in advance, the texture image can be superimposed on a point cloud of the measurement target W with the reference camera 34 as a reference based on the position and posture (the center position information of each of the self-luminous markers 71 to 77, 81 to 87, 91 to 97, and 101 to 107) of the three-dimensional scanner 2 with the reference camera 34 obtained as the reference and the texture image of the measurement target W obtained with the texture camera 66 as the reference.

### Functions and Effects of Embodiment

As described above, the three-dimensional data generation unit 43a of the processing unit 4 can generate the display data indicating the three-dimensional shape of the measurement target W based on the images generated by the scanner imaging parts 64 and 65 of the three-dimensional scanner 2 and the position and posture of the three-dimensional scanner 2 specified by the imaging unit 3. The display data generated by the three-dimensional data generation unit 43a is received by the three-dimensional scanner 2 and displayed as the display screen 210 on the scanner display unit 113 included in the three-dimensional scanner 2.

Therefore, the measurement worker can easily confirm the matters, such as whether the working distance is appropriate, whether the portion desired to be measured in the measurement target W has been irradiated with the pattern light, and how much the current scan completion range is, as the information regarding the measurement result of the three-dimensional scanner 2 only by viewing the scanner display unit 113 close at hand.

Therefore, for example, even when the measurement target W that is large is measured at a place distant from the processing unit 4, the measurement worker does not need to move back and forth between the processing unit 4 and the measurement target W, and measurement workability is improved. Further, information regarding the measurement result can be viewed even during the measurement operation by the three-dimensional scanner 2.

The above-described embodiment is merely an example in all respects, and should not be construed as limiting. Furthermore, all modifications and changes belonging to the equivalent range of the claims fall within the scope of the invention. In the above example, a case where the display screen 210 is a screen displaying the point cloud indicating the three-dimensional shape of the measurement target W has been described, but the invention is not limited thereto, and the display screen may be a screen displaying mesh data indicating the three-dimensional shape of the measurement target W.

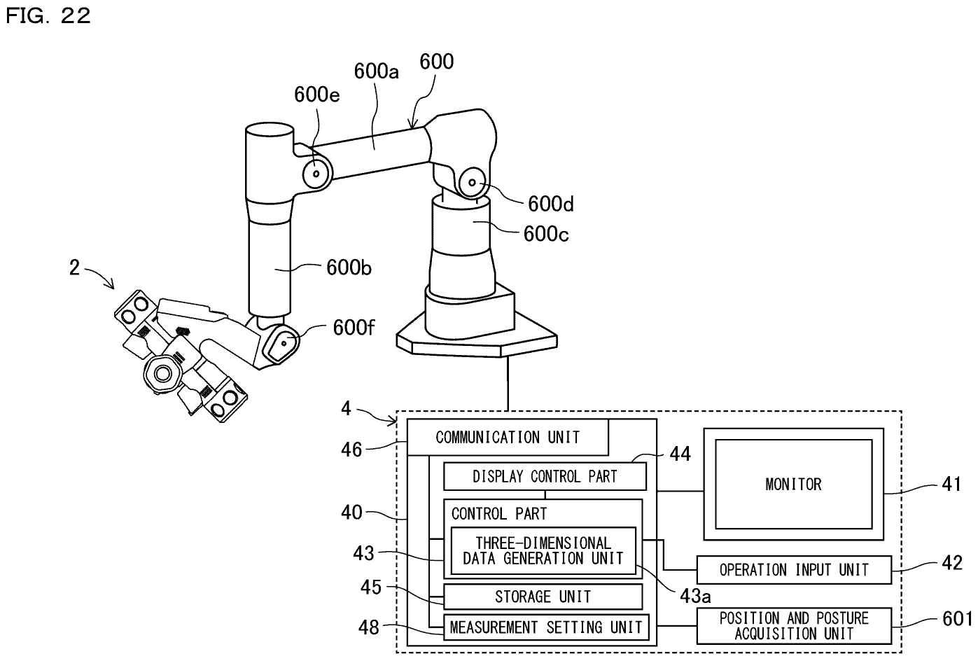

Furthermore, as illustrated in FIG. 22, the invention can also be applied to a case where the three-dimensional scanner 2 is attached to an arm 600 and operated. The arm 600 is a multi-degree-of-freedom arm including a plurality of arm constituent members 600a, 600b, and 600c and rotating parts 600d, 600e, and 600f that rotatably connect the arm constituent members. In this case, a position and posture specifying unit 601 that specifies a position and a posture of the three-dimensional scanner 2 includes a sensor that detects rotation angles of the arm constituent members 600a, 600b, and 600c, and the like. That is, when the rotation angles of the arm constituent members 600a, 600b, and 600c are known, the position and posture of the three-dimensional scanner 2 can be calculated based on a predetermined relational expression.

### Example of Measurement Procedure

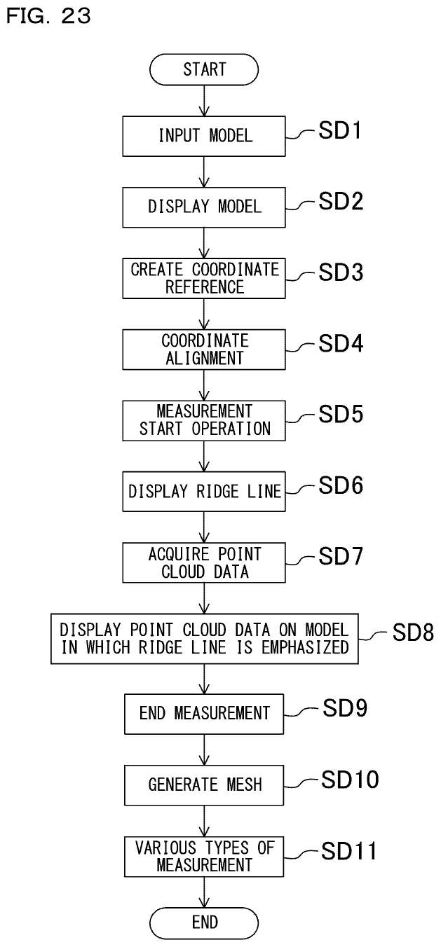

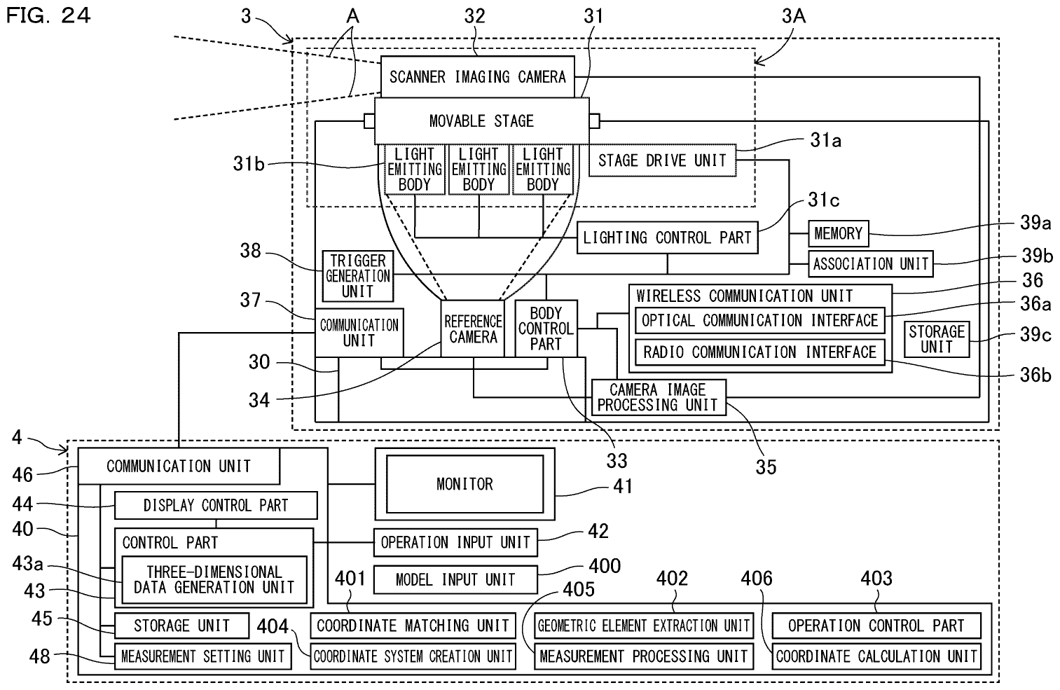

When three-dimensional measurement using the three-dimensional measurement device 1 is performed, a measurement procedure as illustrated in FIG. 23 can also be adopted. As a configuration for implementing this measurement procedure, a configuration illustrated in FIG. 24 can be exemplified. The processing unit 4 includes a model input unit 400, a coordinate matching unit 401, a geometric element extraction unit 402, an operation control part 403, a coordinate system creation unit 404, a measurement processing unit 405, and a coordinate calculation unit 406. A coordinate system matching unit 401, the geometric element extraction unit 402, the operation control part 403, the coordinate system creation unit 404, the measurement processing unit 405, and the coordinate calculation unit 406 are provided in the control unit 40, and are configured by a microcomputer included in the control unit 40, a program executed by the microcomputer, or the like. Hereinafter, a function of each part will be described with reference to a flowchart illustrated in FIG. 23 and the like.

Step SD1 after the start of the flowchart illustrated in FIG. 23 is a model input step. In the model input step, the model input unit 400 executes model input processing. The model input unit 400 is a part that receives an input of a reference model of the measurement target W. The reference model of the measurement target W is a three-dimensional model of the measurement target W, and examples thereof include CAD data, polygon data (STL data), and mesh data acquired in the past. Data of the three-dimensional model of the measurement target W is stored in, for example, the storage unit 45 or another storage unit (not illustrated). The user operates the operation input unit 42 to execute an operation of searching for or specifying the data of the three-dimensional model of the measurement target W, and then executes a reading operation for reading the specified data. When detecting that the reading operation is executed, the model input unit 400 receives an input of the three-dimensional model specified by the user and temporarily stores the input in a predetermined storage area so as to be handled by the processing unit 4. The reference model input by the model input unit 400 has a three-dimensional coordinate system.

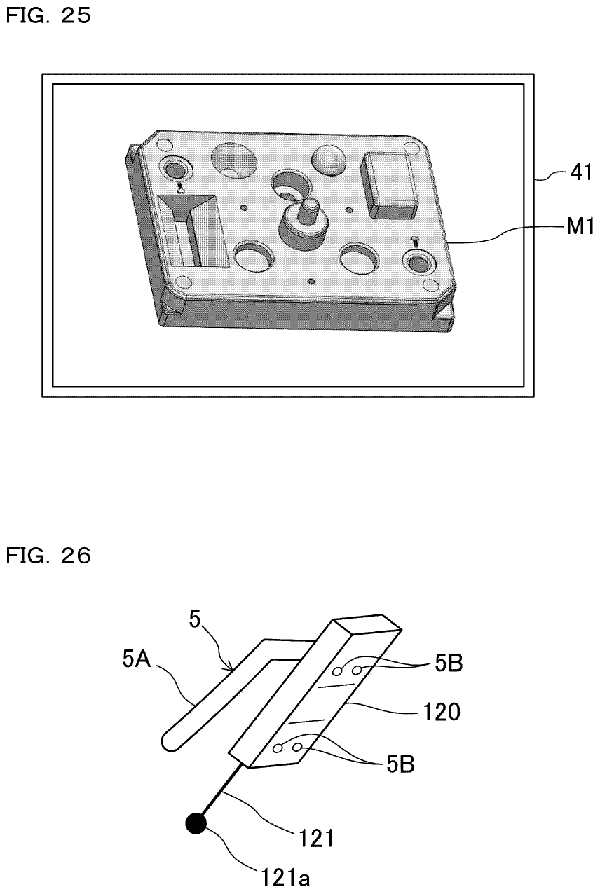

Step SD2 is a model display step. In the model display step, the three-dimensional model of the measurement target W input in Step SD1 is displayed on the monitor 41. At this time, a three-dimensional model M1 is displayed on the monitor 41 as a solid body as illustrated in FIG. 25.

Step SD3 is a step of creating a coordinate reference of the measurement target W. Step SD3 may be performed before Step SD1. In Step SD3, the user uses a contact-type probe 5 (illustrated in FIG. 26) having a plurality of self-luminous markers (probe markers). In the case of using the probe 5, the trigger is transmitted to the probe 5 via the optical communication interface 36a. The optical communication interface 36a is a part configured to perform optical communication using visible light or invisible light, and can be configured by, for example, an infrared communication interface or the like. The wireless communication unit 36 also includes the radio communication interface 36b. The radio communication interface 36b may be, for example, a part configured to construct a wireless LAN, or may be a part capable of short-range digital wireless communication using radio waves such as Bluetooth (registered trademark) communication. The optical communication has characteristics that the directivity is high and the time required for information transfer is accurate.

The imaging unit 3 can track the plurality of probe markers included in the probe 5 and can also capture images of the probe markers. The scanner imaging camera 32 can capture images of probe markers of the probe 5 to generate a probe marker image including the probe markers. The camera image processing unit 35 processes the probe marker image captured by the scanner imaging camera 32 to generate center position information of the probe marker as in the case of the scanner marker. Position and posture information of the probe marker with respect to the movable imaging part 3A can be generated based on the center position information of the probe marker.

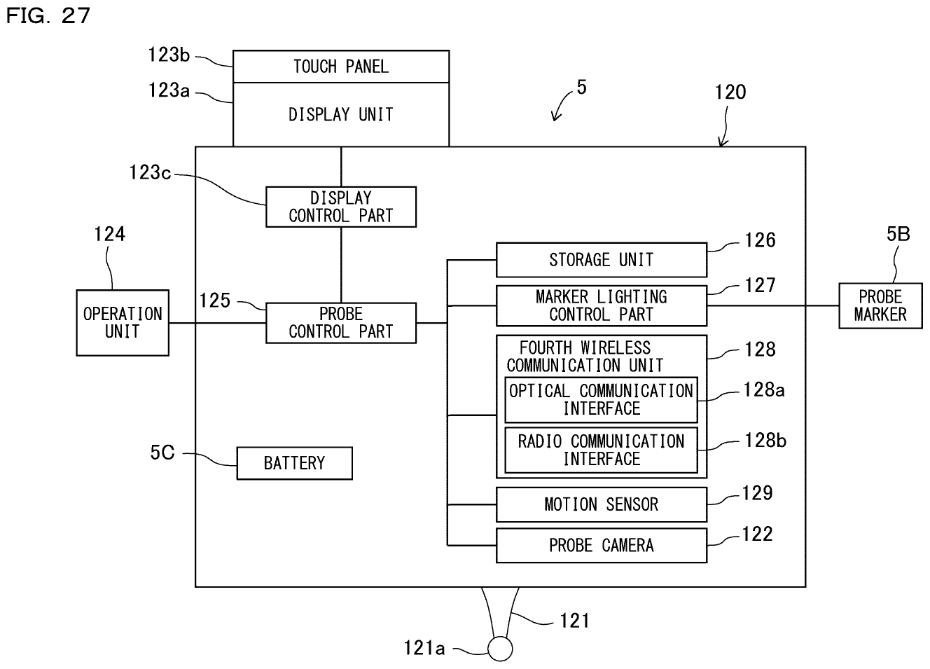

The probe 5 is provided separately from the imaging unit 3 and the processing unit 4, and the measurement worker can bring the probe 5 to the vicinity of the measurement target W located at a place distant from the imaging unit 3 and the processing unit 4 and specify a desired measurement point using the probe 5. Hereinafter, a configuration of the probe 5 will be described with reference to FIGS. 26 and 27.

The contact-type probe 5 is a handheld or portable probe similarly to the three-dimensional scanner 2. As illustrated in FIG. 26, the probe 5 includes a probe body 120 and a stylus 121 protruding from the probe body 120. A contact 121a configured to make contact with the measurement target W is provided at a tip of the stylus 121. The contact 121a has, for example, a spherical shape. The contact 121a is a part configured to indicate a position of a measurement point of the measurement target W. Further, the probe body 120 has a grip part 5A at an intermediate part thereof in the longitudinal direction, and a measurement worker can grip the grip part 5A with one hand and move the probe 5 or change the orientation at the time of measurement.

The probe body 120 is provided with a plurality of probe markers 5B spaced apart from each other. For example, a plurality of probe markers 5B are spaced apart from each other on one end side of the probe body 120 in the longitudinal direction, and a plurality of probe markers 5B are also spaced apart from each other on the other end side of the probe body 120 in the longitudinal direction.

FIG. 27 illustrates a circuit configuration of the probe 5. Although only one probe marker 5B is illustrated in FIG. 27, the plurality of probe markers 5B are provided in practice. A probe camera 122 is provided in the vicinity of the stylus 121. The probe 5 includes a display unit 123a configured by a liquid crystal display, an organic EL display, or the like, a touch panel 123b that is operated by a touch, and a display control part 123c. Further, an operation unit 124 including a plurality of buttons and the like is provided in the vicinity of the display unit 123a. The probe 5 further includes a probe control part 125, a storage unit 126, a probe marker lighting control part 127, a fourth wireless communication unit 128, a motion sensor 129, and the like. Further, the probe 5 also includes a battery 5C serving as a power source.

The display control part 123c is a part that controls the display unit 123a based on a signal output from the probe control part 125, and causes the display unit 123a to display various images, a user interface, and the like. The user's operation performed on the display unit 123a is acquired by the probe control part 125 based on a signal output from the touch panel 123b.

The probe marker lighting control part 127 is a part that controls the probe marker 5B. The probe marker 5B is switched between a turned-on state and a turned-off state by the probe marker lighting control part 127. The probe marker lighting control part 127 is controlled by the probe control part 125. A program and the like can be stored in the storage unit 126.

Similarly to the first wireless communication unit 36 of the imaging unit 3, the fourth wireless communication unit 128 includes an optical communication interface 128a and a radio communication interface 128b. The optical communication interface 128a is a part that receives the trigger transmitted via the optical communication interface 36a of the imaging unit 3. When the trigger is received, the probe marker lighting control part 127 turns on the probe marker 5B. As a result, imaging of the probe marker by the imaging unit 3 and lighting of the probe marker 5B can be synchronized. The radio communication interface 128b may have a radio communication system different from that of the radio communication interface 144b of the three-dimensional scanner 2, and for example, when the radio communication interface 144b of the three-dimensional scanner 2 constructs a wireless LAN, the radio communication interface 128b of the fourth wireless communication unit 128 can be configured as a part capable of Bluetooth communication or the like having a communication speed lower than that of the wireless LAN. Note that, when the radio communication system is different between the radio communication interface 144b of the three-dimensional scanner 2 and the radio communication interface 128b of the probe 5 in this manner, the radio communication interface 36b included in the imaging unit 3 may support both the radio communication interface 144b of the three-dimensional scanner 2 and the radio communication interface 128b of the probe 5. That is, when the radio communication interface 144b of the three-dimensional scanner 2 constructs a wireless LAN and the radio communication interface 128b of the probe 5 constructs Bluetooth communication, the radio communication interface 36b of the imaging unit 3 may support both the wireless LAN and the Bluetooth communication.

Transmission and reception of data between the probe 5 and the imaging unit 3 has a smaller data amount than transmission and reception of data between the three-dimensional scanner 2 and the imaging unit 3 that continuously transmit measurement data. Therefore, the radio communication constructed between the probe 5 and the imaging unit 3 may use Bluetooth communication that consumes less power and is expected to have a long battery life.

The motion sensor 129 includes a sensor that detects an acceleration and an angular velocity of the probe 5, and detected values are output to the probe control part 125 and used for various types of calculation processing such as posture calculation of the probe 5, similarly to the posture calculation of the three-dimensional scanner 2. Coordinates of a plurality of measurement points instructed by the probe 5 are calculated by the coordinate calculation unit 406 illustrated in FIG. 24. For example, the coordinates of the plurality of measurement points instructed by the probe 5 can be calculated based on position and posture information of the probe 5, information output from the imaging unit 3, and the like.

In Step SD3 of FIG. 23, the user holds the probe 5, brings the contact 121a of the stylus 121 into contact with the measurement target W, and performs a measurement operation. As a result, it is possible to acquire three-dimensional coordinates of a portion with which the contact 121a is in contact (a measurement point instructed by the probe 5). This measurement operation is executed a plurality of times while changing a portion with which the contact 121a is brought into contact to acquire positions of a plurality of measurement points, and a coordinate system of display data is generated based on the acquired positions of the plurality of measurement points. The scanner display unit 113 displays the display data indicating a three-dimensional shape of the measurement target W in the coordinate system created based on the positions of the plurality of measurement points instructed by the probe 5.

In Step SD3, coordinate systems are created. The coordinate system creation unit 404 can create a measurement coordinate system based on coordinates of the plurality of measurement points calculated by the coordinate calculation unit 406. Further, a coordinate system of the reference model can also be created based on a geometric element. For example, when receiving an input of position designation on the reference model from the user, the geometric element extraction unit 402 extracts a geometric element at the designated position. Examples of the geometric element to be extracted include a plane, a cylinder, and a circle. In extracting the geometric element, a desired geometric element can be easily selected as compared with a ridge line display (also referred to as a wire frame display) since the three-dimensional model M1 is displayed on the monitor 41 as the solid body as illustrated in FIG. 25. That is, in the case of the ridge line display, it may be difficult for the user to recognize a face of a three-dimensional model, or a part that is not a face may be erroneously recognized as a face, and it may be difficult to select a desired geometric element. On the other hand, when the three-dimensional model M1 is displayed as the solid body, the user can clearly recognize a face, and as a result, it is possible to easily select a desired geometric element without mistakes.

Data for specifying the geometric element extracted by the geometric element extraction unit 402 is sent to the coordinate system creation unit 404. The coordinate system creation unit 404 that has received the data for specifying the geometric element creates the coordinate system of the reference model based on the geometric element extracted by the geometric element extraction unit 402.

Step SD4 is a coordinate alignment processing step. In the coordinate alignment processing step, the coordinate system matching unit 401 illustrated in FIG. 24 executes coordinate alignment processing. Specifically, the coordinate system matching unit 401 is a part that aligns the coordinate system of the reference model input by the model input unit 400 and the coordinate system of the display data generated by the processing unit 4. In aligning both the coordinate systems, the coordinate system matching unit 401 acquires information regarding the coordinate system of the reference model and information regarding the coordinate system of the display data. The coordinate system matching unit 401 that has acquired these pieces of information executes processing of aligning the coordinate system of the reference model and the coordinate system of the display data based on the acquired pieces of information.

Note that the alignment between the reference model and the display data is not necessarily based on coordinates, and may be, for example, alignment using a method such as best fit or three-sided alignment.

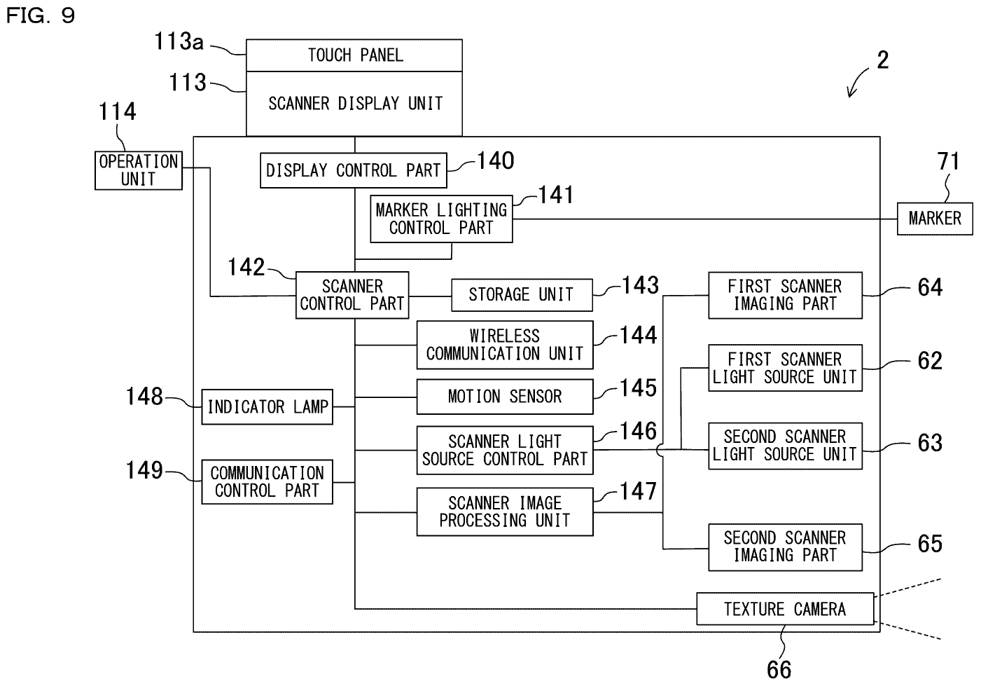

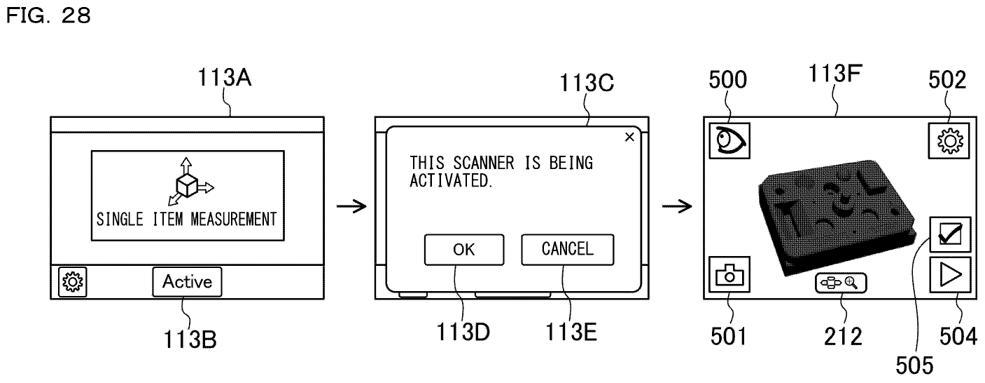

Step SD5 is an input step of an operation of starting shape measurement of the measurement target W by the three-dimensional scanner 2. For example, as illustrated in FIG. 28, when the three-dimensional scanner 2 is in the inactive state, a home screen 113A generated by the display control part 140 is displayed on the scanner display unit 113 (illustrated in FIG. 9) of the three-dimensional scanner 2. When the three-dimensional scanner 2 is in the inactive state, the marker lighting control part 141 turns off the self-luminous markers. As a result, the user can grasp that the three-dimensional scanner 2 is in the inactive state and three-dimensional measurement cannot be performed.

On the other hand, when the user switches the three-dimensional scanner 2 in the inactive state to the active state, the user presses a switch button 113B provided on the home screen 113A. The operation of the switch button 113B is detected by the touch panel 113a illustrated in FIG. 8. When detecting that the switch button 113B has been operated, the display control part 140 generates a message window 113C and displays the message window 113C on the scanner display unit 113. In the message window 113C, an operation confirmation message such as “This scanner is being activated”, an OK button 113D, and a cancel button 113E are displayed. When the touch panel 113a detects that the OK button 113D has been operated, the operation control part 403 switches the three-dimensional scanner 2 from the inactive state to the active state. That is, when an operation input for setting the operation state of the three-dimensional scanner 2 to the active state is detected, the operation control part 403 switches the operation state of the three-dimensional scanner 2 to the active state, and further, the marker lighting control part 141 lights the self-luminous markers.

On the other hand, when the touch panel 113a detects that the cancel button 113E has been operated, the operation control part 403 keeps the three-dimensional scanner 2 in the inactive state.

Further, when an operation input for activating the operation state of the contact-type probe 5 is detected, the operation control part 403 switches the operation state of the three-dimensional scanner 2 to the inactive state. The operation input for activating the operation state of the probe 5 can be the same as the operation input for activating the operation state of the three-dimensional scanner 2.

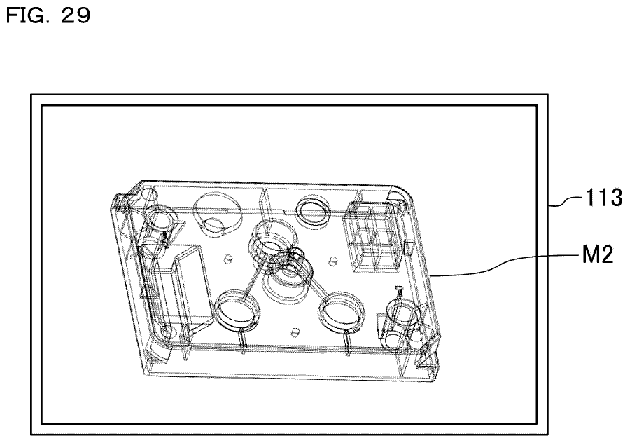

When the operation state of the three-dimensional scanner 2 is switched to be active by the operation control part 403, the display control part 140 generates a measurement screen 113F and displays the measurement screen 113F on the scanner display unit 113. When the measurement is to be started, as illustrated in FIG. 29, the processing unit 4 switches a display form of the reference model from the solid body to a display form in which a ridge line is emphasized. As a result, the reference model in which the ridge line is emphasized is displayed on the scanner display unit 113 of the three-dimensional scanner 2. This display form switching step is Step SD6 in FIG. 23.

The processing unit 4 sequentially generates point cloud data indicating the three-dimensional shape of the measurement target W based on the images including the pattern light generated by the scanner imaging parts 64 and 65 and the position and posture of the three-dimensional scanner 2 specified by the imaging unit 3 in a state where the coordinate system of the reference model and the coordinate system of the display data are aligned by the coordinate system matching unit 401. This step is a point cloud data acquisition step in Step SD7 of FIG. 23.

In generating the point cloud data, the body control part 33 and the scanner control part 142 can receive a switching input for switching between the emission of the multi-line light and the emission of the single-line light. This switching input may be an input from the user or an input by a control signal automatically generated when a predetermined condition is satisfied. In response to the reception of the switching input, the scanner control part 142 controls the first scanner light source 62 to emit the multi-line light from the first scanner light source 62. In a case where the multi-line light is emitted, an emission timing of the multi-line light by the first scanner light source 62, the imaging by the first scanner imaging part 64 and the second scanner imaging part 65, and the light emission of the markers can be synchronized.

Further, in response to the reception of the switching input, the scanner control part 142 controls the second scanner light source 63 to emit the single-line light from the second scanner light source 63. At this time, the scanner control part 142 stops the emission of the multi-line light from the first scanner light source 62, and then executes the emission processing of the single-line light from the second scanner light source 63. In a case where the single-line light is emitted, an emission timing of the multi-line light of the second scanner light source 63, the imaging by the first scanner imaging part 64 and the second scanner imaging part 65, and the light emission of the marker can be synchronized.

The processing unit 4 determines whether any one of the marker blocks 21 to 24 can be detected from the movable imaging part 3A. For example, in a case where a self-luminous marker is included in the second image, the processing unit 4 specifies which marker of the first to fourth marker blocks 21 to 24 the self-luminous marker is, thereby determining which marker block of the first to fourth marker blocks 21 to 24 can be detected. When there is no self-luminous marker included in the second image, the processing unit 4 determines that all the marker blocks 21 to 24 cannot be detected.

In a case where it is determined that any one of the marker blocks 21 to 24 can be detected, the processing unit 4 causes the self-luminous markers included in the marker block that can be detected from the movable imaging part 3A to emit light in a first color having a visible light wavelength. On the other hand, in a case where it is determined that any one of the marker blocks 21 to 24 cannot be detected, the processing unit 4 causes the self-luminous markers included in any one of the marker blocks 21 to 24 that cannot be detected from the movable imaging part 3 A to emit light in a second color different from the first color with a visible light wavelength. For example, the first color can be green, blue, or the like, and the second color can be red, yellow, or the like, but the invention is not limited thereto, and a display form may be different between the case where the detection is possible and the case where the detection is impossible. Further, the first color and the second color are preferably different from a color of light emission of the markers.

Further, the processing unit 4 can determine whether a position and a posture of the three-dimensional scanner 2 can be specified from the movable imaging part 3A based on the second image generated by the movable imaging part 3A, can cause the self-luminous markers included in the marker blocks 21 to 24 to emit light in the first color of the visible light wavelength in a case where it is determined that the position and posture of the three-dimensional scanner 2 can be specified, and can cause the self-luminous markers included in the marker blocks 21 to 24 to emit light in the second color different from the first color with a visible light wavelength in a case where it is determined that the position and posture of the three-dimensional scanner 2 cannot be specified.

When it is determined that the position and posture of the three-dimensional scanner 2 can be specified, the processing unit 4 can cause any one of the marker blocks 21 to 24 that can be detected from the movable imaging part 3A and any one of the marker blocks 21 to 24 that cannot be detected from the movable imaging part 3A to emit light in a distinguishable manner.

The three-dimensional data generation unit 43a can also generate display data so as to display beams of the pattern light included in the images generated by the scanner imaging parts 64 and 65 on the scanner display unit 113 in different colors according to the distance between each of the scanner imaging parts 64 and 65 and the measurement target W. For example, beams of the pattern light are displayed in different colors in the images depending on whether the distance between each of the scanner imaging parts 64 and 65 and the measurement target W is within an appropriate measurement range. As a result, the user can easily discern whether the three-dimensional scanner 2 is within a range where the measurement by the pattern light is appropriate or whether the three-dimensional scanner 2 is outside the range where the measurement by the pattern light is appropriate only by viewing the scanner display unit 113.

Thereafter, the processing proceeds to Step SD8. In Step SD8, when pieces of the sequentially generated point cloud data are displayed on the scanner display unit 113, the processing unit 4 generates display data to be cumulatively displayed on the reference model in which the ridge line is emphasized.

That is, when the measurement by the three-dimensional scanner 2 is executed, a large number of pieces of the point cloud data indicating the three-dimensional shape of the measurement target W are sequentially generated, and the user measures a desired range of the measurement target W by moving the three-dimensional scanner 2 or changing the posture thereof such that a part for which no point cloud data is obtained is irradiated with the pattern light for measurement. At this time, assuming a case where pieces of the point cloud data are superimposed and displayed on the solid body, even in a part for which the point cloud data has been acquired, it may be difficult to distinguish between the solid body and the point cloud, or a front surface of the solid body may be displayed as the point cloud data is not displayed due to a positional relationship with the solid body. Therefore, it is conceivable that the user recognizes that the point cloud data has not been acquired even though the point cloud data has already been acquired, and repeatedly performs a useless measurement operation.

In the present embodiment, after the coordinate matching unit 401 aligns the coordinate system of the reference model with the coordinate system of the display data, the display form is automatically switched from the solid body illustrated in FIG. 25 to the display form illustrated in FIG. 29 in which the ridge line is emphasized before execution of the measurement by the three-dimensional scanner 2 or simultaneously with the execution. Then, as illustrated in FIGS. 12 to 15, the processing unit 4 sequentially superimposes and displays a large number of pieces of the point cloud data indicating the three-dimensional shape of the measurement target W on the reference model illustrated in FIG. 29 in which the ridge line is emphasized. The display form in which the ridge line is emphasized may be a form in which only the ridge line is displayed, or may be a form in which a face is displayed thinly in addition to the ridge line (a display form in which the point cloud data can be seen through from the front side even if the point cloud data exists on the back side of the face). Such a display form of the three-dimensional model can be referred to as translucent display, for example. The translucent display of the face enables the point cloud data existing on the back side to be visually recognized from the front side.

In the display form in which the ridge line is emphasized, the entire ridge line is displayed (both the ridge line on the front surface and the ridge line on the back surface of the model are displayed). However, the display form is not limited to the entire ridge line display, and for example, a display form in which only the ridge line on the front surface is emphasized or a display form in which only the ridge line on the back surface is emphasized may be used. Further, although the display form is automatically switched from the solid body to the display form in which the ridge line is emphasized in the present embodiment, the invention is not limited thereto, and the user's operation of switching the display form may be received and the display form may be switched after the switching operation is received. Further, a timing at which the display form is switched from the solid body to the display form in which the ridge line is emphasized may be a timing after the measurement by the three-dimensional scanner 2 is started.

When the measurement by the three-dimensional scanner 2 is completed in Step SD9, the processing proceeds to Step SD10, and mesh data is generated based on the point cloud data acquired in Step SD7. Specifically, when a user input indicating the measurement completion is made on the touch panel 113a, such an operation is received by the touch panel 113a. The touch panel 113a is an example of an operation unit that receives the user input indicating the measurement completion. For example, when the user presses a completion button 505 on the measurement screen 113F in FIG. 28, such an operation is received by the touch panel 113a as the user input indicating the measurement completion. The user input indicating the measurement completion may be an operation on a physical button or the like other than the operation on the touch panel 113a.

When the user input indicating the measurement completion is input through the touch panel 113a, the processing unit 4 meshes the point cloud data indicating the three-dimensional shape of the measurement target W, and generates display data indicating the meshed three-dimensional shape. At the time of meshing or after meshing, mesh shaping processing such as removal of an inessential point may be performed.

The communication unit 46 of the processing unit 4 transmits the display data indicating the meshed three-dimensional shape to the wireless communication unit 144 of the three-dimensional scanner 2. The display control part 140 transmits, to the scanner display unit 113, the display data indicating the meshed three-dimensional shape transmitted from the communication unit 46 of the processing unit 4. The scanner display unit 113 displays a display screen generated based on the display data indicating the meshed three-dimensional shape received via the wireless communication unit 144. As a result, the user can confirm the display data indicating the meshed three-dimensional shape close at hand.

Thereafter, the processing proceeds to Step SD11 to measure a dimension, a shape, and the like. The measurement processing unit 405 illustrated in FIG. 24 executes measurement processing (also referred to as measurement processing) of the three-dimensional shape of the measurement target W based on a series of the point cloud data acquired in Step SD7. Examples of the executable measurement processing include geometric measurement, comparative measurement, and cross-section measurement.

Further, in a case where the texture capturing button 501 is operated by the user, the three-dimensional data generation unit 43a acquires a texture image at a predetermined time point by the texture camera 66. The texture image at the predetermined time point can be an image that is within a field of view of the texture camera 66 at a time point when the texture capturing button 501 is operated.

The processing unit 4 sequentially generates the point cloud data over a predetermined period (for example, from start of the measurement to completion of the measurement). The processing unit 4 generates display data for superimposing and displaying the texture image at the predetermined time point acquired by the texture camera 66 on the cumulatively displayed pieces of the point cloud data sequentially generated over the predetermined period. The communication unit 46 of the processing unit 4 transmits the display data to the wireless communication unit 144 of the three-dimensional scanner 2. The scanner display unit 113 displays a display screen generated based on the display data for superimposing and displaying the texture image.

On the display screen, the reference model input by the model input unit 400 can be compared with the point cloud data acquired by the three-dimensional scanner 2. For example, the processing unit 4 acquires the reference model and the point cloud data, and calculates a difference between the point cloud data and the reference model. The processing unit 4 generates display data of the difference in a heat map format based on the calculated difference. The display data in the heat map format as illustrated in FIG. 17 can also be displayed. In the display data in the heat map format, a display color varies according to the magnitude of the difference, so that the user can easily grasp a portion where the difference between the reference model and the point cloud data is large and a portion where the difference is small.

Switching from the display data on which the texture image is superimposed to the display data in the heat map format is performed by receiving the user's switching operation. When the operation of switching the display data on which the texture image is superimposed to the display data in the heat map format is received, the processing unit 4 hides the texture. This makes it easier to see the display in the heat map format.

### INDUSTRIAL APPLICABILITY

As described above, the present invention can be used in the case of measuring three-dimensional shapes of various measurement targets.

### REFERENCE SIGNS LIST

1: THREE-DIMENSIONAL MEASUREMENT DEVICE
2: THREE-DIMENSIONAL SCANNER
3: IMAGING UNIT (POSITION AND POSTURE SPECIFYING UNIT)
4: PROCESSING UNIT (THREE-DIMENSIONAL DATA GENERATION MECHANISM)
37: COMMUNICATION UNIT (THIRD COMMUNICATION UNIT)
43: CONTROL PART (MEASUREMENT CONTROL PART)
46: COMMUNICATION UNIT (SECOND COMMUNICATION UNIT)
48: MEASUREMENT SETTING UNIT
62, 63: SCANNER LIGHT SOURCE
64, 65: SCANNER IMAGING PART
71 TO 77: FIRST TO SEVENTH SCANNER MARKERS
113: SCANNER DISPLAY UNIT
144: WIRELESS COMMUNICATION UNIT (FIRST COMMUNICATION UNIT)
601: POSITION AND POSTURE SPECIFYING UNIT

1. A three-dimensional measurement device that measures a three-dimensional shape of a measurement target, the three-dimensional measurement device comprising:
a three-dimensional scanner including a scanner light source that emits pattern light, a scanner imaging part that captures the pattern light emitted by the scanner light source to generate an image including the pattern light, a scanner display unit, and a first communication unit that receives display data for generating a display screen to be displayed on the scanner display unit;
a position and posture specifying unit that specifies a position and a posture of the three-dimensional scanner;
a three-dimensional data generation mechanism that generates display data indicating the three-dimensional shape of the measurement target based on the image including the pattern light generated by the scanner imaging part and the position and the posture of the three-dimensional scanner specified by the position and posture specifying unit; and
a second communication unit that transmits the display data generated by the three-dimensional data generation mechanism,
wherein the first communication unit of the three-dimensional scanner receives the display data transmitted via the second communication unit, and
the scanner display unit displays the display screen generated based on the display data received via the first communication unit.

2. The three-dimensional measurement device according to claim 1, wherein
the three-dimensional scanner further includes a scanner image processing unit that processes the image including the pattern light generated by the scanner imaging part to generate first measurement information,
the first communication unit transmits the first measurement information,
the three-dimensional data generation mechanism generates point cloud data indicating the three-dimensional shape of the measurement target and display data corresponding to the point cloud data based on the first measurement information transmitted by the first communication unit and the position and the posture of the three-dimensional scanner specified by the position and posture specifying unit, and
the second communication unit transmits the display data generated by the three-dimensional data generation mechanism.

3. The three-dimensional measurement device according to claim 1, wherein
the three-dimensional scanner further includes a scanner image processing unit that processes the image including the pattern light generated by the scanner imaging part to generate first measurement information, and a plurality of self-luminous markers, the first measurement information being transmitted by the first communication unit,
the position and posture specifying unit includes a movable imaging part that moves a field of view to make the three-dimensional scanner be within the field of view and captures the self-luminous markers to generate an image including the self-luminous markers in order to measure the position and the posture of the three-dimensional scanner, a camera image processing unit that processes the image including the self-luminous markers generated by the movable imaging part to generate second measurement information, and a third communication unit that transmits the second measurement information generated by the camera image processing unit,
the three-dimensional data generation mechanism receives the first measurement information generated by the scanner image processing unit and transmitted via the first communication unit and the second measurement information generated by the camera image processing unit and transmitted via the third communication unit, and generates the display data indicating the three-dimensional shape of the measurement target based on the received first measurement information and the received second measurement information,
the three-dimensional data generation mechanism transmits the display data to the three-dimensional scanner, and
the first communication unit of the three-dimensional scanner receives the display data transmitted from the three-dimensional data generation mechanism.

4. The three-dimensional measurement device according to claim 1, wherein the three-dimensional data generation mechanism further includes a measurement setting unit that receives a setting of at least one of a type of the pattern light emitted by the scanner light source and an exposure time of the scanner imaging part, and a measurement control part that controls the scanner light source or the scanner imaging part based on the setting received by the measurement setting unit.

5. The three-dimensional measurement device according to claim 4, wherein the scanner display unit displays a setting screen that receives the setting of at least one of the type of the pattern light emitted by the scanner light source and the exposure time of the scanner imaging part.

6. The three-dimensional measurement device according to claim 5, wherein
setting information received via the setting screen is written into the measurement setting unit of the three-dimensional data generation mechanism, and
the measurement control part of the three-dimensional data generation mechanism controls the scanner light source or the scanner imaging part based on the setting information written in the measurement setting unit.

7. The three-dimensional measurement device according to claim 6, wherein
the three-dimensional data generation mechanism generates new display data indicating the three-dimensional shape of the measurement target based on a new image including the pattern light generated by the scanner imaging part controlled based on the setting information written in the measurement setting unit and the position and the posture of the three-dimensional scanner specified by the position and posture specifying unit, and transmits the generated new display data, and
the scanner display unit displays a display screen generated based on the new display data received via the first communication unit.

8. The three-dimensional measurement device according to claim 1, wherein the scanner display unit displays the display screen having a display area of distance information representing a distance between the measurement target and the three-dimensional scanner.

9. The three-dimensional measurement device according to claim 1, wherein the scanner display unit displays the display screen showing difference information representing a difference between CAD data of the measurement target and the three-dimensional shape of the measurement target generated by the three-dimensional data generation mechanism.

10. The three-dimensional measurement device according to claim 1, further comprising a texture camera that generates a color image of the measurement target,
wherein the scanner display unit displays the display screen in which the color image of the measurement target generated by the texture camera is superimposed and displayed on a point cloud indicating the three-dimensional shape of the measurement target generated based on the display data.

11. The three-dimensional measurement device according to claim 1, further comprising:
a model input unit that receives an input of a reference model of the measurement target; and
a coordinate system matching unit that aligns a coordinate system of the reference model input by the model input unit and a coordinate system of the display data generated by the three-dimensional data generation mechanism,
wherein the three-dimensional data generation mechanism sequentially generates point cloud data indicating the three-dimensional shape of the measurement target based on the image including the pattern light generated by the scanner imaging part and the position and the posture of the three-dimensional scanner specified by the position and posture specifying unit in a state where the coordinate system of the reference model and the coordinate system of the display data generated by the three-dimensional data generation mechanism are matched by the coordinate system matching unit, and generates display data for cumulatively displaying pieces of the sequentially generated point cloud data on the reference model in which a ridge line is emphasized.

12. The three-dimensional measurement device according to claim 11, further comprising:
a geometric element extraction unit that extracts a geometric element by receiving a user input on the reference model; and
a coordinate system creation unit that creates the coordinate system of the reference model based on the geometric element extracted by the geometric element extraction unit,
wherein the coordinate system matching unit aligns the coordinate system of the reference model created by the coordinate system creation unit and the coordinate system of the display data generated by the three-dimensional data generation mechanism.

13. The three-dimensional measurement device according to claim 12, wherein the geometric element extraction unit extracts the geometric element by receiving the user input on the reference model displayed as a solid body on the scanner display unit.

14. The three-dimensional measurement device according to claim 1, further comprising a contact-type probe that indicates a position of a measurement point,
wherein a coordinate system of the display data is generated based on positions of a plurality of the measurement points indicated by the contact-type probe.

15. The three-dimensional measurement device according to claim 14, further comprising an operation control part that controls an operation state of the three-dimensional scanner and an operation state of the contact-type probe,
wherein the operation control part switches the operation state of the contact-type probe to be inactive when an operation input for activating the operation state of the three-dimensional scanner is detected, and switches the operation state of the three-dimensional scanner to be inactive when an operation input for activating the operation state of the contact-type probe is detected.

16. The three-dimensional measurement device according to claim 15, wherein the scanner display unit displays the display data indicating the three-dimensional shape of the measurement target in the coordinate system created based on positions of the plurality of measurement points indicated by the contact-type probe.

17. The three-dimensional measurement device according to claim 1, wherein
the three-dimensional scanner further includes an operation unit that receives a user input indicating measurement completion,
when the user input indicating the measurement completion is input by the operation unit, the three-dimensional data generation mechanism meshes point cloud data indicating the three-dimensional shape of the measurement target and generates display data indicating the meshed three-dimensional shape,
the second communication unit transmits the display data indicating the meshed three-dimensional shape generated by the three-dimensional data generation mechanism to the first communication unit, and
the scanner display unit displays the display screen generated based on the display data indicating the meshed three-dimensional shape received via the first communication unit.
